(19) United States
(12) Patent Application Publication
(10) Pub. No.: US 2018/0218710 A1
(43) Pub. Date: Aug. 2, 2018

(54) ELECTRONIC DEVICE AND DISPLAY CONTROL METHOD IN ELECTRONIC DEVICE

(71) Applicant: Samsung Electronics Co., Ltd., Suwon-si, Gyeonggi-do (KR)

(72) Inventors: Hyun-Hee PARK, Seoul (KR); Sung-Oh KIM, Suwon-si (KR); Jae-Moon KIM, Uiwang-si (KR); Yong-Man LEE, Seongnam-si (KR); Kyoung-Min PARK, Seoul (KR); Kee-Hyon PARK, Suwon-si (KR); Dae-Keun PARK, Suwon-si (KR); Seul-Ki JANG, Suwon-si (KR); Hyung-Ju CHUN, Hwaseong-si (KR); Jong-Bum CHOI, Yongin-si (KR); Kwang-Tai KIM, Suwon-si (KR); Soo-Hyung KIM, Hwaseong-si (KR); Dong-Hyun YEOM, Bucheon-si (KR); Ki-Huk LEE, Suwon-si (KR)

(21) Appl. No.: 15/741,632

(22) PCT Filed: Jul. 5, 2016
(86) PCT No.: PCT/KR2016/007267

§ 371 Date: Jan. 3, 2018

Related U.S. Application Data
(60) Provisional application No. 62/188,932, filed on Jul. 6, 2015.

(30) Foreign Application Priority Data
May 26, 2016 (KR) 10-2016-0064994

(51) Int. Cl. G09G 5/10

(52) U.S. Cl. CPC G09G 5/10; G09G 2320/0626

(57) ABSTRACT

Various examples of the present invention provide an electronic device comprising: a display for displaying content in a direction corresponding to a first surface of the electronic device; a sensor for sensing light incident on a second surface of the electronic device; and a processor, wherein the processor determines information of the brightness around the electronic device, at least on the basis of the sensed light, and can be set to adjust at least one attribute of the display or at least one attribute of the content. In addition, other examples besides the various examples of the present invention are possible.

### TECHNICAL FIELD

The present disclosure relates generally to a method and device for controlling a property of a display which displays content or for controlling a property of the displayed content, by an electronic device.

### BACKGROUND ART

Electronic devices refer to devices which perform a predetermined function corresponding to an installed program. Such devices include a home appliance, an electronic scheduler, a portable multimedia player, a mobile communication terminal, a tablet PC, an video/audio device, a desktop/laptop computer, a navigation unit for a vehicle, and the like. For example, the electronic devices may output stored information via sound or images. With the increase of degree of integration of an electronic device and the popularization of hyper-speed and high capacity wireless communication, recently, a single mobile communication terminal has various functions.

For example, in addition to a communication function, an entertainment function such as a game, a multimedia function such as reproduction of a music file and a video file, a communication and security function for mobile banking, a scheduling function, an electronic wallet function, etc. are integrated into a single electronic device.

As the functions of electronic devices are verified, the electronic devices may include various sensors to implement various functions. For example, an illuminance sensor installed in the front side of an electronic device may measure surrounding brightness, and may adjust luminance of a display or the like using the measured value, whereby visibility of a user can be increased.

### DETAILED DESCRIPTION OF THE INVENTION

### Technical Problem

When an electronic device uses only a value sensed by an illuminance sensor installed in the front side of the electronic device in order to adjust luminance of a display, the electronic device may not apply the same in the case of a backlit situation, whereby user visibility may be reduced.

According to various embodiments of the present disclosure, an electronic device and a display control method performed by the electronic device are provided, wherein the electronic device adjusts the property of a display and the property (e.g., luminance, chroma, color, or the like) of content displayed through the display, using, for example, values sensed by sensors functionally connected to the electronic device.

According to various embodiments of the present disclosure, an electronic device and a display control method performed by the electronic device are provided, wherein the electronic device adjusts the property of a display or the property (e.g., luminance, chroma, color, or the like) of content displayed through the display, using an illuminance sensor installed in one side of the electronic device and an image sensor installed in another side.

### Technical Solution

To solve the above described problem or other problems, an electronic device according to an embodiment may include: a display for displaying content in a direction corresponding to a first side of the electronic device; a sensor for sensing light incident to a second side of the electronic device; and a processor, wherein the processor is configured to perform: determining brightness information around the electronic device at least based on the sensed light; and adjusting at least one property of the display or at least one property of the content at least based on the brightness information.

A display control method of an electronic device according to any one of various embodiments may include: displaying content by a display installed in a first side of the electronic device; sensing incident light by a sensor installed in a second side of the electronic device; determining brightness information around the electronic device at least based on the sensed light; and adjusting at least one property of the display or at least one property of the content at least based on the brightness information.

A nontemporary computer readable recording medium stores a program to be implemented on a computer according to one of various embodiments, the program including an executable instruction which enables a processor to perform: displaying content by a display; sensing incident light by a sensor; determining brightness information around the electronic device at least based on the sensed light; and adjusting at least one property of the display or at least one property of the content at least based on the brightness information, when the program is executed by the processor.

### Advantageous Effects

An electronic device and a display control method performed by the electronic device according to various embodiments may adjust the property of a display or the property (e.g., luminance, chroma, or color) of content displayed through the display, using a sensor contained in one side of the electronic device and a sensor installed in another side, whereby visibility of a user can be improved.

Also, when the difference in brightness is high due to the surrounding environment of the front side and the back side of a display of the electronic device, an illuminance sensor in the front side may be used together with a brightness value obtained by an image sensor in the back side, whereby the limitation of an automatic brightness function that operates using only the illuminance sensor in the front side may can be overcome.

### BRIEF DESCRIPTION OF DRAWINGS

FIG. 1 illustrates a network environment according to an embodiment of the present disclosure;

FIG. 2 illustrates an example of the configuration of an electronic device according to an embodiment of the present disclosure;

FIG. 3 is a flowchart illustrating a procedure of controlling a display by an electronic device according to various embodiments of the present disclosure;

FIG. 4a is a flowchart illustrating a procedure of controlling the luminance or color of a display by an electronic device according to various embodiments of the present disclosure;

FIG. 4b is a flowchart illustrating a procedure of controlling the luminance of a display by an electronic device according to various embodiments of the present disclosure;

FIG. 5a is a flowchart illustrating a procedure of controlling the color of a display by an electronic device according to various embodiments of the present disclosure;

FIG. 5b is a flowchart illustrating a procedure of controlling the luminance of a display using an image sensor by an electronic device according to various embodiments of the present disclosure;

FIG. 6a is a flowchart illustrating a procedure of controlling the luminance of a display in the case of a backlit environment under an automatic brightness operation state, by an electronic device according to various embodiments of the present disclosure;

FIG. 6b is a flowchart illustrating a procedure of controlling the luminance of a display using an illuminance sensor and an image sensor by an electronic device according to various embodiments of the present disclosure;

FIG. 7 is a flowchart illustrating a procedure of controlling a display based on content by an electronic device according to various embodiments of the present disclosure;

FIGS. 8a and 8b are perspective views of an electronic device in which sensors according to various embodiments of the present disclosure are disposed;

FIG. 9 is a block diagram illustrating a configuration of an image processing device according to various embodiments of the present disclosure;

FIG. 10 is a diagram illustrating detailed blocks of an image pre-processing module according to various embodiments of the present disclosure;

FIG. 11 is a diagram illustrating detailed blocks of an image signal processing unit according to various embodiments of the present disclosure;

FIG. 12 is a block diagram illustrating a configuration of an image processing device according to various embodiments of the present disclosure;

FIG. 13 is a block diagram illustrating a configuration of an image processing device according to various embodiments of the present disclosure;

FIG. 14 is a block diagram illustrating a configuration of an image processing device according to various embodiments of the present disclosure;

FIGS. 15a and 15b are block diagrams illustrating configurations of an image processing device according to various embodiments of the present disclosure;

FIG. 16 is a block diagram of an electronic device according to an embodiment of the present disclosure; and

FIG. 17 is a block diagram of a program module according to various embodiments of the present disclosure.

### MODE FOR CARRYING OUT THE INVENTION

Hereinafter, various embodiments of the present disclosure will be described with reference to the accompanying drawings. However, it should be understood that there is no intent to limit the present disclosure to particular forms, and the present disclosure should be construed to cover all modifications, equivalents, and/or alternatives falling within the spirit and scope of the embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” may include (1) at least one A, (2) at least one B, or (3) both at least one A and at least one B.

The expression “a first”, “a second”, “the first”, or “the second” used in various embodiments of the present disclosure may modify various components regardless of the order and/or the importance but does not limit the corresponding components. The above-described expressions may be used to distinguish an element from another element. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

As used herein, the expression “configured to” may be interchangeably used with the expression “suitable for”, “having the capability to”, “designed to”, “adapted to”, “made to”, or “capable of”. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., Central Processing Unit (CPU) or Application Processor (AP)) that can perform the corresponding operations by executing one or more software programs stored in a memory device.

The terms used in the present disclosure are only used to describe specific embodiments, and are not intended to limit the present disclosure. A singular expression may include a plural expression unless they are definitely different in a context. Unless defined otherwise, all terms used herein, including technical terms and scientific terms, may have the same meaning as commonly understood by a person of ordinary skill in the art to which the present disclosure pertains. Terms, such as those defined in commonly used dictionaries, should be interpreted as having a meaning that is the same or similar to their meaning in the context of the relevant art and will not be interpreted in an idealized or overly formal sense unless expressly so defined herein. In some cases, eve the terms defined herein may not be construed to exclude embodiments of the present disclosure.

An electronic device according to various embodiments of the present disclosure, for example, may include at least one of a smartphone, a tablet Personal Computer (PC), a mobile phone, a video phone, an electronic book (e-book) reader, a desktop PC, a laptop PC, a netbook computer, a workstation, a server, a personal digital assistant (PDA), a Portable Multimedia Player (PMP), an MP3 player, a mobile medical appliance, a camera, and a wearable device (e.g., smart glasses, a Head-Mounted-Device (HMD), electronic clothes, an electronic bracelet, an electronic necklace, an electronic appcessory, an electronic tattoo, a smart mirror, or a smart watch).

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an Automatic Teller's Machine (ATM) in banks, Point Of Sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Various embodiments of the present disclosure disclose an electronic device and a display control method performed by the electronic device, wherein the electronic device may control the property of a display and the property (e g, luminance, chroma, color, or the like) of content displayed through the display, using values sensed by a plurality of sensors installed in the electronic device. For example, various embodiments of the present disclosure disclose an electronic device and a display control method performed by the electronic device, wherein the electronic device may control the property of a display or the property (e.g., luminance, chroma, color, or the like) of content displayed on the display, using an illuminance sensor installed in one side of the electronic device and an image sensor installed in another side.

In various embodiments of the present disclosure described below, “illuminance” will be used as an example of a value corresponding to “brightness”. However, the various embodiments of the present disclosure may not be limited to the illuminance. For example, as a value corresponding to the “brightness”, a luminance, a luminous flux, a luminous intensity, or the like may be included in addition to the illuminance. Also, in the various embodiments of the present disclosure described below, “chroma” is a major attribute of color indicating the degree to which a color is pure or dusky, and is expressed as a number. Also, in the various embodiments of the present disclosure described below, “color” may be interpreted as a concept including chroma in a broad sense. Also, in the various embodiments of the present disclosure described below, “white balance (WB)” may indicate the distribution of colors, and may indicate a value obtained by digitizing the distribution of R, G, or B value. The white balance may be calculated from an RGB histogram sensed through an image sensor.

Hereinafter, an electronic device according to various embodiments will be described with reference to the accompanying drawings. In the present disclosure, the term “user” may indicate a person using an electronic device or a device (e.g., an artificial intelligence electronic device) using an electronic device.

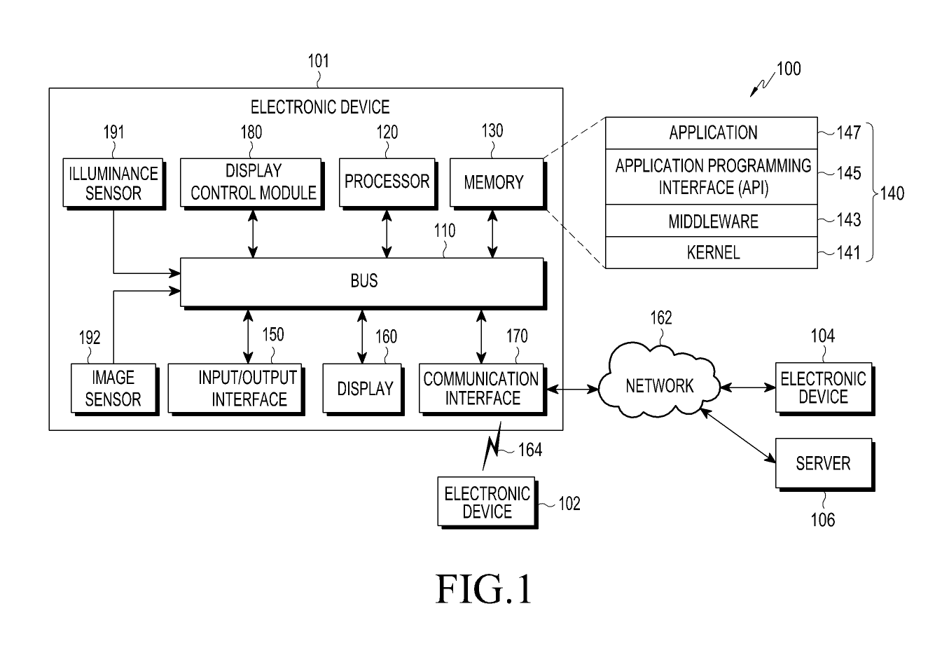

An electronic device 101 in a network environment 100 according to various embodiments will be described with reference to FIG. 1. The electronic device 101 may include at least one of a bus 110, a processor 120, a memory 130, an input/output interface 150, a display 160, a communication interface 170, a display control module 180, an illuminance sensor 191, and an image sensor 192. According to an embodiment, the electronic device 101 may omit at least one of the elements or further include other elements.

The bus 110 may include, for example, a circuit for connecting the elements 110 to 192 each other, and transferring communication (e.g., a control message and/or data) between the elements.

The processor 120 may include one or more of a central processing unit (CPU), an application processor (AP), and a communication processor (CP). For example, the processor 120 may carry out operations or data processing related to control and/or communication of at least one other element of the electronic device 101.

The memory 130 may include a volatile and/or non-volatile memory. The memory 130 may store, for example, instructions or data related to at least one other element of the electronic device 101. According to an embodiment of the present disclosure, the memory 130 may store software and/or a program 140. The program 140 may include a kernel 141, middleware 143, an Application Programming Interface (API) 145, and/or an application program (or “application”) 147. At least some of the kernel 141, the middle 143, and the API 145 may be referred to as an Operating System (OS).

The kernel 141 may control or manage system resources (e.g., the bus 110, the processor 120, or the memory 130) used for executing an operation or function implemented by other programs (e.g., the middleware 143, the API 145, or the application program 147). Furthermore, the kernel 141 may provide an interface through which the middleware 143, the API 145, or the application program 147 may access individual elements of the electronic device 101 to control or manage system resources.

The middleware 143 may serve as an intermediary such that, for example, the API 145 or the application program 147 communicate with the kernel 141 to transmit/receive data. Furthermore, in regard to task requests received from the application program 147, the middleware 143 may perform control (e.g., scheduling or load balancing) for the task requests using, for example, a method of assigning at least one application a priority to use the system resources (e.g., the bus 110, the processor 120, or the memory 130) of the electronic device 101.

The API 145 is an interface by which the applications 147 control functions provided from the kernel 141 or the middleware 143, and may include, for example, at least one interface or function (e.g., instructions) for file control, window control, image processing, or text control.

The input/output interface 150 may serve as an interface that may transfer instructions or data, which is input from a user or another external device, to another element(s) of the electronic device 101. Further, the input/output interface 150 may output instructions or data received from another element(s) of the electronic device 101 to a user or another external device.

The display 160 is a unit for providing display by adjusting the property (e.g., luminance, chroma, or color) of a screen provided to a user according to various embodiments of the present disclosure, and may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display various types of contents (e.g., text, images, videos, icons, or symbols) to users. The display 160 may include a touch screen, and may receive, for example, a touch input, a gesture input, a proximity input, or a hovering input using an electronic pen or a user's body part.

The communication interface 170 may configure communication between, for example, the electronic device 101 and an external device (e.g., a first external electronic device 102, a second external electronic device 104, or a server 106). For example, the communication interface 170 may be connected to a network 162 through wireless or wired communication to communicate with the external device (e.g., the second external electronic device 104 or the server 106). Also, the communication interface 170 may directly communicate with the external device (e.g., the first external electronic device 102) through, for example, wireless communication or wired communication. In the embodiments described below, when the electronic device 101 is a smart phone, the first external electronic device 102 may be a wearable device. For example, when a smart phone and a wearable device communicate with each other according to various embodiments of the present disclosure, they may transmit or receive information related to an electronic map.

The wireless communication may use at least one of, for example, long-term evolution (LTE), LTE-advanced (LTE-A), code division multiple access (CDMA), wideband CDMA (WCDMA), universal mobile telecommunications system (UMTS), WiBro (Wireless Broadband), global system for mobile communications (GSM), or the like, as a cellular communication protocol. In addition, the wireless communication may include, for example, short-range communication 164. The short-range communication 164 may include at least one of, for example, Wi-Fi, Bluetooth, Near Field Communication (NFC), and Global Navigation Satellite System (GNSS). The GNSS may include at least one of, for example, a global positioning system (GPS), a global navigation satellite system (Glonass), a Beidou navigation satellite system (hereinafter referred to as “Beidou”), and a European global satellite-based navigation system (Galileo), according to a area where the GBSS is used, a bandwidth, or the like. Hereinafter, in the present disclosure, the “GPS” may be interchangeably used with the “GNSS”. The wired communication may include, for example, at least one of a universal serial bus (USB), a high definition multimedia interface (HDMI), recommended standard 232 (RS-232), a plain old telephone service (POTS), and the like. The network 162 may include at least one of a communication network such as a computer network (e.g., a LAN or a WAN), the Internet, and a telephone network.

Each of the first and second external electronic devices 102 and 104 may be a device of a type which is the same as or different from the electronic device 101. According to an embodiment of the present disclosure, the server 106 may include a group of one or more servers. According to various embodiments of the present disclosure, all or some of the operations performed by the electronic device 101 may be performed by another electronic device or a plurality of electronic devices (e.g., the electronic device 102 or 104 or the server 106). According to an embodiment of the present disclosure, when the electronic device 101 needs to perform some functions or services automatically or in response to a request, the electronic device 101 may request another device (e.g., the electronic device 102 or 104 or the server 106) to perform at least some functions related to the functions or services, instead of, or in addition to, performing the functions or services by itself. The other electronic device (e.g., the electronic device 102 or 104 or the server 106) may carry out the requested function or the additional function, and transfer the result to the electronic device 101. The electronic device 101 may provide the requested functions or services based on the received result as it is or after additionally processing the received result. To this end, for example, cloud computing, distributed computing, or client-server computing technology may be used.

Although it is illustrated that the electronic device 101 includes the communication interface 170 to communicate with the external electronic device 104, the server 106, or the like through the network 162 in FIG. 1, the electronic device 101 may be implemented to independently operate in the electronic device 101 without a separate communication function according to various embodiments of the present disclosure.

According to an embodiment of the present disclosure, the server 106 may support driving of the electronic device 101 by performing at least one operation (or function) of operations (or functions) implemented in the electronic device 101. For example, the server 106 may include a display control server module (not illustrated) capable of supporting the display control module 180 implemented in the electronic device 101. For example, the display control server module may include at least one element of the display control module 180, and may execute at least one operation of the operations (or functions) executed by the display control module 180 (or may execute the same as a substitute for the display control module 180). Also, according to various embodiments of the present disclosure, the server 106 may be an image editing function providing server, which may provide various image editing related functions to the electronic device 101.

The display control module 180 may process at least a part of information obtained from other elements (e.g., the processor 120, the memory 130, the input/output interface 150, or the communication interface 170), and may provide the processed information to a user in various ways.

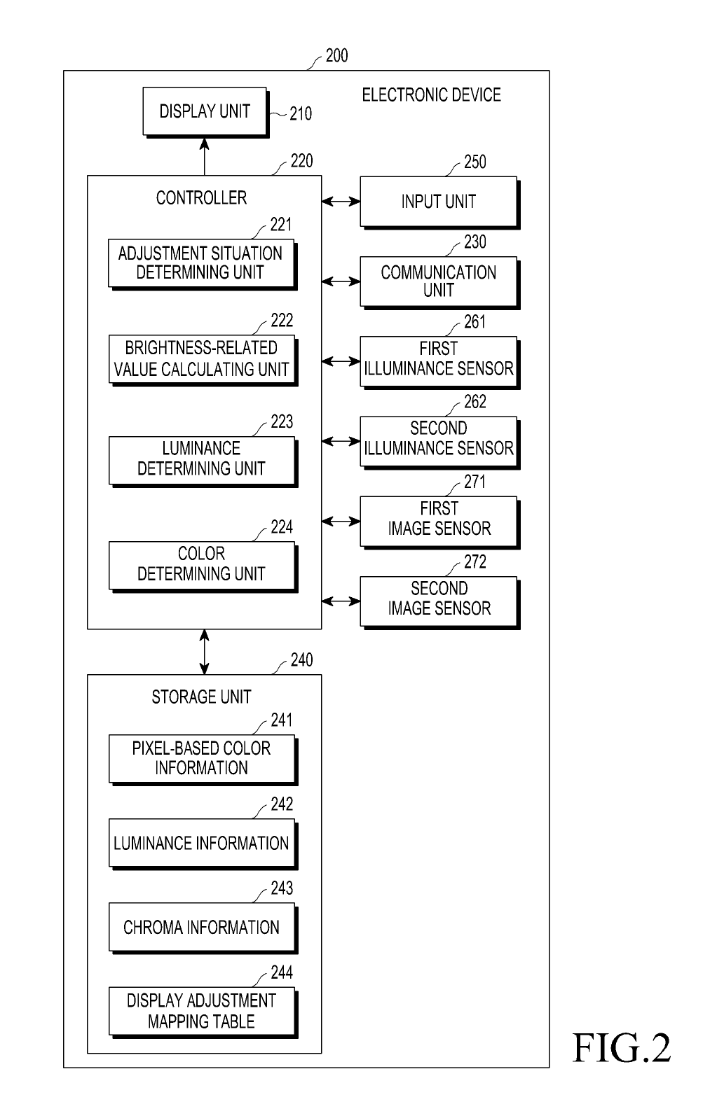

For example, the display control module 180 may adjust or determine the property (e.g., luminance, chroma, or color) of a screen displayed on the display 160 based on a value sensed by at least one illuminance sensor 191 or at least one image sensor 192 according to various embodiments of the present disclosure. Through the following descriptions with reference to FIG. 2, additional information associated with the display control module 180 will be provided.

Although FIG. 1 illustrates the display control module 180 as a separate module from the processor 120, at least a part of the display control module 180 may be embodied in the processor 120 or at least one other module (e.g., the display 160), or the entire functions of the display control module 180 may be embodied in the processor 120 or another processor.

The illuminance sensor 191 may be, for example, a sensor for sensing a value related to brightness, and may not be limited to a sensor having a predetermined name. All types of sensors which can determine a value related to brightness by sensing may be included in an illuminance sensor according to an embodiment of the present disclosure.

The image sensor 192 may be, for example, a sensor for detecting light incident to a sensor, and sensing a value related to brightness or color for each pixel, and may not be limited to a sensor having a predetermined name. All types of sensors which can determine a value related to brightness or color for each pixel based on an incident light may be included in an image sensor according to an embodiment of the present disclosure. For example, at least a part of a camera module may be included in the image sensor 192.

According to an embodiment, although it is illustrated that all of the elements of the electronic device 101 (e.g., the processor 120 or the display control module 180) are included in the electronic device 101, various embodiments may not be limited thereto. For example, according to a role, a function, or performance of the electronic device 101, at least a part of the elements of the electronic device 101 may be separately embodied in the electronic device 101 and an external electronic device (e.g., the first external electronic device 102, the second external electronic device 104, of the server 106 of FIG. 1).

FIG. 2 illustrates an example of the configuration of an electronic device according to an embodiment of the present disclosure. According to various embodiments of the present disclosure, an electronic device 200 may include at least one of a display unit 210, a controller 220, a communication unit 230, a storage unit 240, an input unit 250, at least one illuminance sensor 261 and 262, and at least one image sensor 271 and 272. Also, according to various embodiments of the present disclosure, the controller 220 may include at least one of an adjustment situation determining unit 221, a brightness-related value calculating unit 222, a luminance determining unit 223, and a color determining unit 224.

According to various embodiments of the present disclosure, the first illuminance sensor 261 may be disposed in one side (e.g., the front side) of the electronic device 200, and the second illuminance sensor 262 may be disposed in another side (e.g., the back side) of the electronic device 200. Also, according to various embodiments of the present disclosure, the first image sensor 271 may be disposed in one side (e.g., the front side or the top side) of the electronic device 200, and the second image sensor 272 may be disposed in another side (e.g., the back side or the bottom side) of the electronic device 200. A side where the display unit 210 of the electronic device 200 is located may be determined as the front side of the electronic device 200, and the opposite side of the front side may be determined as the back side. One side and another side of the electronic device 200 may not be limited to mutually opposite sides, such as the front side and the back side, and the front side or a lateral side of the electronic device 200 may be determined as one side and another side.

The entirety or a part of the functions of each element of the electronic device 200 of FIG. 2 may be included in at least one element of FIG. 1. For example, at least a part of the controller 220 may be included in the display control module 180 or the processor 120 of FIG. 1. Also, at least a part of the storage unit 240 may be included in the memory 130 of FIG. 1, at least a part of the display unit 210 may be included in the display 160 of FIG. 1, and at least a part of the communication unit 230 may be included in the communication interface 170 of FIG. 1.

The storage unit 240 may include, for example, pixel-based color or brightness information 241, luminance information 242, chroma information 243, and information on a display adjustment mapping table 244. The information stored in the storage unit 240 may be provided from an external electronic device (e.g., a server or another electronic device) of the electronic device 200. Also, various pieces of information related to controlling a display may be additionally stored in the storage unit 240.

The adjustment situation determining unit 221 of the controller 220 may determine whether a situation requires adjustment of the property (e.g., luminance, chroma, or color) of the display unit 210 (e.g., the display 160) or the property (e.g., luminance, chroma, or color) of content displayed through the display unit 210. For example, the adjustment situation determining unit 221 determines whether a predetermined condition for adjusting the property (e.g., luminance, chroma, or color) of the display 160 or the property (e.g., luminance, chroma, or color) of content displayed through the display unit 210 is satisfied, and, when the condition is satisfied, the luminance determining unit 223 or the color determining unit 224 of the controller 220 may determine the property (e.g., luminance, chroma, or color) of the display unit 210 or the property (e g, luminance, chroma, or color) of content displayed through the display unit 210 using a value sensed by at least one illuminance sensor 261 and 262 or at least one image sensor 271 and 272.

The situation that requires adjusting luminance, chroma, or color of the screen or content displayed on the screen may be variously set. For example, according to various embodiments of the present disclosure, it is embodied that the luminance, chroma, or color of the screen or the luminance, chroma, or color of content displayed on the screen are adjusted when the display unit 210 is currently on or when the display unit 210 is being turned on.

Also, according to various embodiments of the present disclosure, it is embodied that the luminance, chroma, or color of the screen or those of content displayed on the screen are adjusted periodically. For example, the second illuminance sensor 262 or the second image sensor 272 disposed in one side (e.g., the back side) of the electronic device 200 may be operated at regular time intervals, so as to sense brightness information or the like of the side (e.g., the back side) of the electronic device 200.

Also, according to various embodiments of the present disclosure, it is embodied that the luminance, chroma, or color of the screen or those of content displayed on the screen are adjusted when movement of the electronic device 200 occurs. For example, it is embodied that the luminance, chroma, or color of the screen or the luminance, chroma, or color of content displayed on the screen are adjusted when movement of the electronic device 200 is sensed by various motion detecting sensor (e.g., a gyro sensor, an acceleration sensor, or the like) installed in the electronic device 200, or when the degree of the movement is beyond a predetermined threshold value. Also, according to various embodiments of the present disclosure, it is embodied that the luminance, chroma, or color of the screen or those of content displayed on the screen are adjusted when a user of the electronic device 200 moves from the inside of a building to the outside or moves from the outside to the inside of the building and a dramatic change in brightness instantly occurs.

Also, according to various embodiments, it is embodied that the luminance, chroma, or color of the screen or the luminance, chroma, or color of content displayed on the screen are adjusted using a sensor (e.g., the second illuminance sensor 262 or the second image sensor 272) installed in another side (e.g., the back side) of the electronic device 200 when a predetermined event occurs (e.g., when a user presses a power button to check time, a message, or the like) in the state in which a sensor (e.g., the first illuminance sensor 261 or the first image sensor 271) installed in one side (e.g., the front side) of the electronic device 200 is covered by a cover of the electronic device 200.

Also, according to various embodiments of the present disclosure, when a virtual reality content reproduced by the electronic device 200 is terminated, the property of a screen or the property (e.g., luminance, chroma, or color) of content displayed on the screen may be controlled through the display unit 210 by adjusting the luminance, chroma, or color of the screen or the luminance, chroma, or color of the content displayed on the screen using a sensor (e.g., the second illuminance sensor 262 or the second image sensor 272) installed in one side (e.g., the back side) before viewing the content is finished, whereby a user can have light adaptation to a sudden change in the brightness of a surrounding.

Also, according to various embodiments of the present disclosure, the property of a preview screen displayed on the display unit 210 may be changed when a camera performs shooting (e.g., when a camera performs shooting using at least one image sensor 271 and 272), and a camera which is to display the preview screen may be selected from among a plurality of image sensors 271 and 272.

For example, according to various embodiments of the present disclosure, it is embodied that the luminance, white balance, or the like of a preview screen are changed or a camera setting value is changed based on surrounding illuminance information or color information determined through the at least one sensor 261, 262, 271, and 272, when the camera performs shooting. Also, it is embodied that an electronic device including a plurality of cameras drives only one of the cameras based on illuminance determined by a sensor, to display a preview image.

Also, according to various embodiments of the present disclosure, in the case in which the electronic device is a wearable device that provides a virtual reality (VR) function, when a user wears the electronic device, the brightness of the internal screen of the electronic device may be different from the brightness of the outside of the electronic device. In this situation, the user may recognize the situation based on information obtained from a sensor installed in the front side or the back side of the electronic device, before taking off the electronic device, and may appropriately adjust the brightness of the display. For example, when the user determines that the brightness of an internal screen of the electronic device is dark and the brightness of the outside of the electronic device is bright based on the information obtained from the sensor installed in the front side or the back side of the electronic device a predetermined time before the user finishes viewing VR content, the brightness of the display is adjusted before viewing of VR content is terminated, whereby the user may be prevented from being dazzled when the user takes off the electronic device.

For example, as described above, when the electronic device operates in a VR mode, and VR-related content is reproduced, a user is disconnected from the external environment in the VR mode, and thus, it may be relatively dark. However, when the VR mode is terminated, it is instantly converted to a bright state, whereby the eyes of the user may not adapt to the state. According to various embodiments of the present disclosure, when the VR-related content is terminated, back side information of the electronic device may be displayed on a screen in an overlay manner such that the user can adapt to a sudden change in the environment. The back side information displayed in an overlay manner may be set to be brighter gradually as a point in time when the VR-related content is to be terminated becomes closer.

When the adjustment situation determining unit 211 determines that a situation requires adjustment of the luminance, chroma, or color of the screen or the luminance, chroma, or color of content displayed on the screen, as described above, the luminance or the chroma of the screen or those of the content displayed on the screen may be adjusted by at least one of the brightness-related value calculating unit 222, the luminance determining unit 223, and the color determining unit 224 based on a value sensed by the at least one illuminance sensor 261 and 262 or the at least one image sensor 271 and 272.

For example, the brightness-related value calculating unit 222 may generate an RGB histogram from a value sensed by the first image sensor 271 or the second image sensor 272, and may calculate a brightness-related value (e.g., illuminance), white balance, or the like from the generated RGB histogram and/or exposure time. Detailed embodiments thereof will be described as follows. Each pixel-based color information 241 sensed by the first image sensor 271 or the second image sensor 272 may be stored in the storage unit 240.

The luminance determining unit 223 may adjust or determine the luminance of the screen or the luminance of content displayed on the screen based on a value sensed by at least one of the first illuminance sensor 261, the second illuminance sensor 262, the first image sensor 271 and the second image sensor 272, or a combination of values sensed by two or more of them. The determined luminance information 242 may be stored in the storage unit 240.

For example, according to various embodiments of the present disclosure, the luminance may be determined based on a value sensed by the first illuminance sensor 261 installed in one side (e.g., the front side) of the electronic device 200, and a value sensed by the second illuminance sensor 262 installed in another side (e.g., the back side) of the electronic device 200. Also, according to various embodiments of the present disclosure, the luminance may be determined based on a value sensed by the first illuminance sensor 261 installed in one side (e.g., the front side) of the electronic device 200, and a value sensed by the second image sensor 272 installed in another side (e.g., the back side) of the electronic device 200. Detailed embodiments thereof will be described as follows.

The chroma determining unit 224 may adjust or determine the luminance of the screen or the luminance of content displayed on the screen based on a value sensed by at least one of the first illuminance sensor 261, the second illuminance sensor 262, the first image sensor 271, and the second image sensor 272, or a combination of values sensed by two or more of them.

For example, according to various embodiments of the present disclosure, the chroma or color may be determined based on a value sensed by the first image sensor 271 installed in one side (e.g., the front side) of the electronic device 200, and a value sensed by the second image sensor 272 installed in another side (e.g., the back side) of the electronic device 200.

According to various embodiments of the present disclosure, the luminance determining unit 223 or the color determining unit 224 may identify and determine the luminance, chroma, or color to be applied to a screen or content displayed on the screen through the display adjustment mapping table 244, based on a value sensed by at least one sensor (the first illuminance sensor 261, the second illuminance sensor 262, the first image sensor 271, and the second image sensor 272.

According to various embodiments of the present disclosure, the controller 220 may perform calculation of the electronic device 200, and may further process various functions that control the operations of the electronic device 200. For example, the controller 220 may be an application processor (AP), or a separate processor designed to consume low power. Alternatively, the controller 220 may be configured by being included in a modem processor, or may be included in a processor of a separate communication module or a positioning module.

The communication unit 230 may be a device that wirelessly and wiredly communicates with another electronic device excluding the electronic device 200, or a server. The other electronic device may be another mobile device, or may be a stationary access point (AP), a Bluetooth low energy (BLE), a beacon, or the like. Alternatively, the other electronic device may be a base station on a mobile communication network. The input unit 250 may process various types of user inputs for setting functions of the electronic device 200 or for instructing operations. For example, the input unit 250 may include a touch pad of a touch screen, a hardware button, a user gesture, or the like.

Each functional unit or module in various embodiments of the present disclosure may indicate a functional or structural coupling of hardware for executing a technical idea of various embodiments of the present disclosure and software for operating the hardware. For example, the each functional unit or module may indicate a predetermined code and a unit of logic of a hardware resource for performing the predetermined code. However, it will be understood by a person skilled in the technical field of the present disclosure that the each functional unit or module does not mean the physically connected codes, or one kind of hardware.

According to various embodiments, at least some of the adjustment situation determining unit 221, the brightness-related value calculating unit 222, the luminance determining unit 223, and the color determining unit 224 may be embodied as software, firmware, hardware, or a combination of at least two of them. At least some of the adjustment situation determining unit 221, the brightness-related value calculating unit 222, the luminance determining unit 223, and the color determining unit 224 may be implemented (e.g., executed) by, for example, a processor (e.g., the processor 120). At least some of the adjustment situation determining unit 221, the brightness-related value calculating unit 222, the luminance determining unit 223, and the color determining unit 224 may include, for example, modules, programs, routines, sets of instructions, or processes, or the like, for implementing one or more functions.

An electronic device according to one of the various embodiments of the present disclosure may include: a display;

a first sensor disposed in the front side of the electronic device; a second sensor disposed in the back side of the electronic device; and a controller for performing control such that luminance of the display is determined based on a value sensed by the first sensor and a value sensed by the second sensor.

According to various embodiments of the present disclosure, the controller may perform control such that illuminance is determined based on a value sensed by the first sensor, the color value of each pixel is determined based on a value sensed by the second sensor, and the luminance of the display is determined based on the illuminance and the color value of each pixel.

According to various embodiments of the present disclosure, the first sensor may be an illuminance sensor and the second sensor may be an image sensor.

According to various embodiments of the present disclosure, the electronic device may further include an image signal processing unit for receiving and performing image signal processing on the color value of each pixel sensed by the second sensor, and transmitting the result of the image signal processing to the controller.

According to various embodiments of the present disclosure, the image signal processing unit includes a plurality of functional blocks, and, when a predetermined condition for determining the luminance of the display is satisfied, the controller may turn off at least one of the plurality of functional blocks.

According to various embodiments of the present disclosure, the image signal processing unit includes a plurality of functional blocks mutually connected in the form of a pipeline, and, when a predetermined condition for determining the luminance of the display is satisfied, the controller may bypass at least one of the plurality of functional blocks.

According to various embodiments of the present disclosure, the electronic device may further include an image pre-processing module disposed between the second sensor and the image signal processing unit, and when a predetermined condition for determining the luminance of the display is satisfied, the controller may turn off at least one functional block from among a plurality of functional blocks included in the image pre-processing module.

According to various embodiments of the present disclosure, the controller determines whether a predetermined condition for determining the luminance of the display is satisfied, and, when the predetermined condition is satisfied, the controller may process data received from the first sensor or the second sensor.

According to various embodiments, the predetermined condition may include at least one of: the case in which the display is in the on-state, the case in which the display is switched from the off-state to the on-state, the case in which a predetermined period is satisfied, the case in which movement of the electronic device occurs, the case in which the degree of movement of the electronic device is beyond a predetermined threshold value, the case in which a user of the electronic device moves from the inside of a building to the outside or moves from the outside to the inside, the case in which a dramatic change in brightness around the electronic device occurs, the case in which a cover of the electronic device is closed and the first sensor or the second sensor is covered by the cover, and the case in which a predetermined event occurs in the state in which the cover is closed.

An electronic device according to any one of the various embodiments of the present disclosure may include: a display for displaying content in a direction corresponding to a first side of the electronic device; a sensor for sensing light incident to a second side of the electronic device; and a processor, wherein the processor is configured to perform: determining brightness information around the electronic device at least based on the sensed light; and adjusting at least one property of the display or at least one property of the content at least based on the brightness information.

According to various embodiments of the present disclosure, the electronic device may further include another sensor for sensing light incident to the first side, and the processor may be configured to perform the above described determination when another brightness information, which is determined based on light sensed by the other sensor, belongs to a designated range.

According to various embodiments of the present disclosure, the electronic device may further include another sensor for sensing light incident to the first side, and the processor may be configured to perform the above described adjustment further based on another brightness information, which is determined based on light sensed by the other sensor.

According to various embodiments of the present disclosure, the sensor may include an image sensor.

According to various embodiments of the present disclosure, the electronic device may further include an image signal processing unit including a first functional block and a second functional block, for processing the light obtained from the sensor, and the processor may be configured to select a functional block related to the brightness information from among the first functional block and the second functional block, and to perform the above described determination using the selected functional block.

According to various embodiments of the present disclosure, the processor may be configured to bypass a functional block, which is not selected from among the first functional block and the second functional block, during the determining, or to turn off power applied to the second functional block.

According to various embodiments of the present disclosure, the sensor includes a plurality of pixels including a red pixel, a green pixel, or a blue pixel, and the processor may be configured to perform the above described determination based on color information corresponding to a pixel designated from among the plurality of pixels.

According to various embodiments of the present disclosure, the processor may be configured to select, as the designated pixel, one or more pixels, the number of which is the smallest from among the plurality of pixels.

According to various embodiments of the present disclosure, the processor may be configured to determine the brightness information based color information corresponding to the light.

According to various embodiments of the present disclosure, the processor may be configured to determine the brightness information further based on time information when the sensor is exposed to the light.

According to various embodiments of the present disclosure, the at least one property of the display or the at least one property of the content may include luminance (brightness), chroma, white balance, color, or a combination thereof.

According to various embodiments of the present disclosure, the electronic device may further include a housing forming at least a part of an external surface of the electronic device, and the sensor may form at least a part of the housing.

According to various embodiments of the present disclosure, the sensor may be located between the display and the housing.

According to various embodiments of the present disclosure, the electronic may further include an image pre-processing module between the sensor and the processor, and the processor turns off at least one functional block from among a plurality of functional blocks included in the image pre-processing module when a predetermined condition for determining brightness of the display is satisfied.

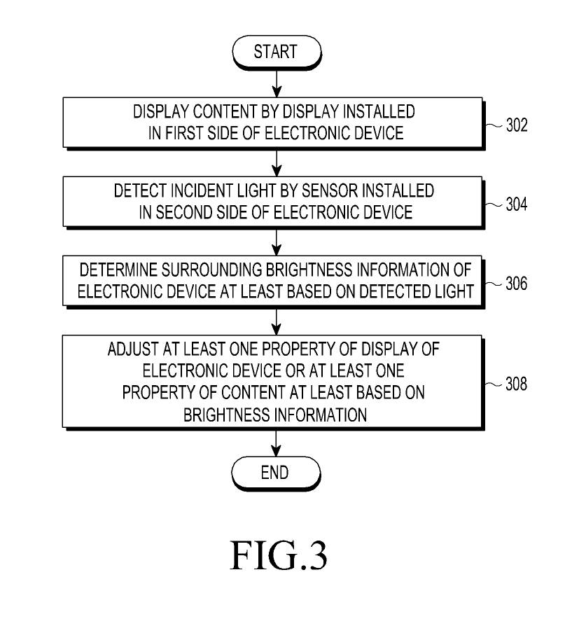

Hereinafter, referring to FIGS. 3 to 8, a display control procedure according to various embodiments of the present disclosure will be provided.

FIG. 3 is a flowchart illustrating a procedure of controlling a display (e.g., the display 160) by an electronic device (e.g., the processor 120 or the display control module 180) according to various embodiments of the present disclosure.

Referring to FIG. 3, in operation 302, the electronic device (e.g., the processor 120) may display content through a display (e.g., the display 160) installed in a first side of the electronic device. In operation 304, incident light is sensed by a sensor installed in a second side of the electronic device. In operation 306, the electronic device determines surrounding brightness information of the electronic device at least based on the sensed light. In operation 308, the electronic device may determine at least one property of the display of the electronic device or at least one property (e.g., luminance, chroma, or color) of the content at least based on the brightness information of the electronic device.

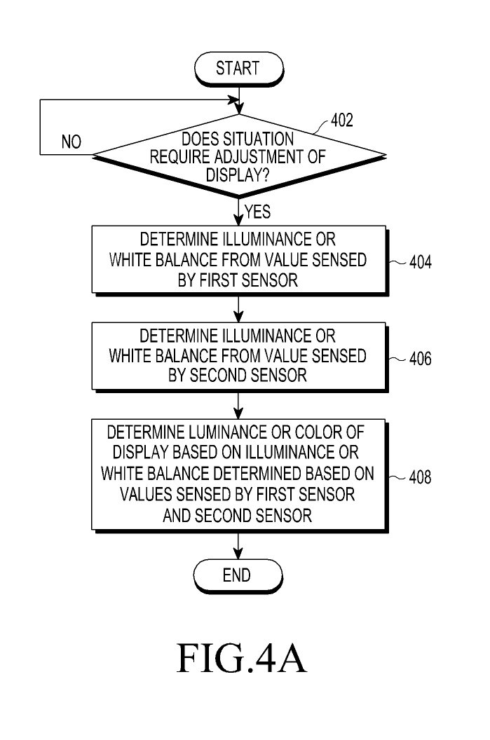

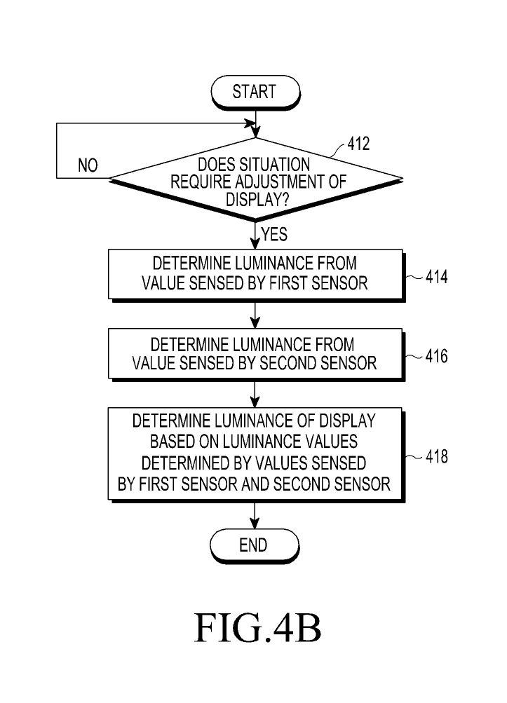

FIG. 4A is a flowchart illustrating a procedure of controlling the luminance or color of a display (e.g., the display 160) by an electronic device (e.g., the processor 120 or the display control module 180) according to various embodiments of the present disclosure.

Referring to FIG. 4A, in operation 402, the electronic device (e.g., the processor 120) may determine whether a situation requires adjustment of the display. According to an embodiment, in operation 402, when the display unit is currently on or when the display unit is being turned on, the electronic device periodically determines whether the situation requires adjustment of the display. As another example, when a movement of the electronic device occurs, when a dramatic change in brightness instantly occurs since a user of the electronic device moves from the inside of a building to the outside or from the outside to the inside, when a predetermined event occurs in the state in which at least one sensor installed in the electronic device is covered by a cover of the electronic device, and when virtual reality content reproduced by the electronic device is terminated, the electronic device may determine that the situation requires adjustment of the display.

In operation 402, when the result of comparison or determination corresponds to the situation that requires adjustment of the display, the electronic device (e.g., the processor 120) may proceed with, for example, operation 404. According to an embodiment, in operation 404, the electronic device determines illuminance or white balance from a value sensed by a first sensor.

In operation 402, when the result of comparison or determination does not correspond to the situation that requires adjustment of the display, the electronic device (e.g., the processor 120) may proceed with, for example, operation 402 again.

In operation 406, the electronic device (e.g., the processor 120) may identify or determine illuminance or white balance from a value sensed by, for example, a second sensor.

According to various embodiments of the present disclosure, the first sensor and the second sensor may be disposed in the same plane of the electronic device, or may be disposed in different planes (e.g., the front side or the back side). Also, the first sensor and the second sensor may be the same types of sensors (e.g., the first sensor and the second sensor may be illuminance sensors or image sensors), or may be different types of sensors (e.g., the first sensor is an illuminance sensor and the second sensor is an image sensor, or the first sensor is an image sensor and the second sensor is an illuminance sensor).

In operation 408, the electronic device may identity, determine, or adjust the property of the display (e.g., the display 160) or the property of content displayed through the display, based on illuminance or white balance determined based on values sensed by the first sensor and the second sensor. The property may include, for example, the luminance, chroma, or color of a screen. Detailed embodiments thereof will be described as follows.

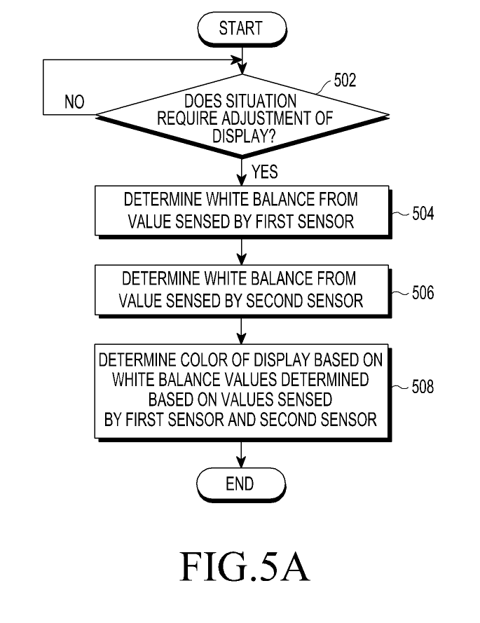

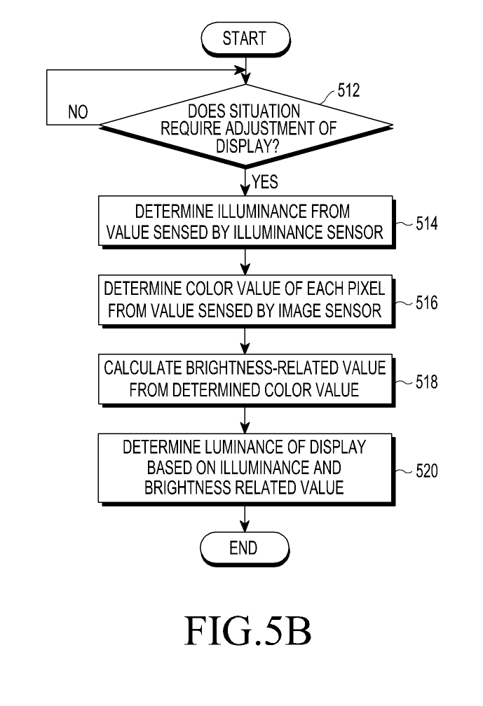

Hereinafter, referring to FIGS. 4B to 5B, various embodiments of determining the luminance, chroma, or color based on a combination of values sensed by the plurality of sensors will be described.

FIG. 4B is a flowchart illustrating a procedure of controlling the luminance of a display (e.g., the display 160) by an electronic device (e.g., the processor 120 or the display control module 180) according to various embodiments of the present disclosure. Referring to FIG. 4B, in operation 412, the electronic device (e.g., the processor 120) may determine whether a situation requires adjustment of the display. According to an embodiment, in operation 412, when the display unit is currently on or when the display unit is being turned on, the electronic device periodically determines whether the situation requires adjustment of the display. As another example, when a movement of the electronic device occurs, when a dramatic change in brightness instantly occurs since a user of the electronic device moves from the inside of a building to the outside or from the outside to the inside, when a predetermined event occurs in the state in which at least one sensor installed in the electronic device is covered by a cover of the electronic device, and when virtual reality content reproduced by the electronic device is terminated, the electronic device may determine that the situation requires adjustment of the display.

In operation 412, when the result of comparison or determination corresponds to the situation that requires adjustment of the display, the electronic device (e.g., the processor 120) may proceed with, for example, operation 414. According to an embodiment, in operation 414, the electronic device determines the luminance of the display from a value sensed by a first sensor. For example, the electronic device identifies or determines illuminance or white balance from the value sensed by the first sensor, and may determine or decide luminance to be applied to the display or content to be displayed through the display based on the determined illuminance or white balance. Also, in operation 416, the electronic device may determine the luminance of the display from a sensor sensed by a second sensor. For example, the electronic device identifies or determines illuminance or white balance from the value sensed by the second sensor, and may determine or decide luminance to be applied to the display or content to be displayed through the display based on the determined illuminance or white balance.

According to various embodiments of the present disclosure, the first sensor and the second sensor may be disposed in the same plane of the electronic device, or may be disposed in different planes (e.g., the front side or the back side). Also, the first sensor and the second sensor may be the same types of sensors, and may be different types of sensors (e.g., the first sensor is an illuminance sensor and the second sensor is an image sensor).

In operation 412, when the result of comparison or determination does not correspond to the situation that requires adjustment of the display, the electronic device (e.g., the processor 120) may proceed with, for example, operation 412 again.

In operation 418, the electronic device may determine, decide, or adjust the luminance of the display or content displayed through the display based on the luminance determined based on the value sensed by the first sensor and the luminance determined based on the value sensed by the second sensor. Detailed embodiments thereof will be described as follows.

FIG. 5A is a flowchart illustrating a procedure of controlling the chroma of a display (e.g., the display 160) by an electronic device (e.g., the processor 120 or the display control module 180) according to various embodiments of the present disclosure. Referring to FIG. 5, in operation 502, the electronic device (e.g., the processor 120) may determine whether a situation requires adjustment of the display. According to an embodiment, in operation 502, when the display unit is currently on or when the display unit is being turned on, the electronic device periodically determines whether the situation requires adjustment of the display. As another example, when a movement of the electronic device occurs, when a dramatic change in brightness instantly occurs since a user of the electronic device moves from the inside of a building to the outside or from the outside to the inside, when a predetermined event occurs in the state in which at least one sensor installed in the electronic device is covered by a cover of the electronic device, and when virtual reality content reproduced by the electronic device is terminated, the electronic device may determine that the situation requires adjustment of the display.

In operation 502, when the result of comparison or determination corresponds to the situation that requires adjustment of the display, the electronic device (e.g., the processor 120) may proceed with, for example, operation 504. According to an embodiment, in operation 504, the electronic device identifies or determines white balance from a value sensed by a first sensor. Also, in operation 506, the white balance may be identified or determined based on a value sensed by a second sensor.

In operation 502, when the result of comparison or determination does not correspond to the situation that requires adjustment of the display, the electronic device (e.g., the processor 120) may proceed with, for example, operation 502 again.

According to various embodiments of the present disclosure, the first sensor and the second sensor may be disposed in the same plane of the electronic device, or may be disposed in different planes (e.g., the front side or the back side). Also, the first sensor and the second sensor may be the same types of sensors, and may be different types of sensors. For example, the first sensor and the second sensor may be an image sensor installed in the front side of the electronic device (e.g., a sensor forming a front camera module) and an image sensor installed in the back side of the electronic device (e.g., a sensor forming a back side camera module).

In operation 508, the electronic device may identity, determine, or adjust the chroma or color of the display (e.g., the display 160) or content displayed through the display, based on illuminance or white balance identified or determined based on values sensed by the first sensor and the second sensor.

FIG. 5B is a flowchart illustrating a procedure of controlling the luminance of a display (e.g., the display 160) using an image sensor by an electronic device (e.g., the processor 120 or the display control module 180) according to various embodiments of the present disclosure. Referring to FIG. 5B, in operation 512, the electronic device (e.g., the processor 120) may determine, for example, whether a situation requires adjustment of the display.

According to an embodiment, in operation 512, when the display unit is currently on or when the display unit is being turned on, the electronic device periodically determines whether the situation requires adjustment of the display. As another example, when a movement of the electronic device occurs, when a dramatic change in brightness instantly occurs since a user of the electronic device moves from the inside of a building to the outside or from the outside to the inside, when a predetermined event occurs in the state in which at least one sensor installed in the electronic device is covered by a cover of the electronic device, and when virtual reality content reproduced by the electronic device is terminated, the electronic device may determine that the situation requires adjustment of the display.

In operation 512, when the result of comparison or determination corresponds to the situation that requires adjustment of the display, the electronic device (e.g., the processor 120) may proceed with, for example, operation 514. According to an embodiment, in operation 514, the electronic device identifies or determines illuminance from a value sensed by an illuminance sensor. Also, in operation 516, the electronic may identify or determine the color value of each pixel from a value sensed by an image sensor.

In operation 512, when the result of comparison or determination does not correspond to the situation that requires adjustment of the display, the electronic device (e.g., the processor 120) may proceed with, for example, operation 512 again.

According to various embodiments of the present disclosure, the illuminance sensor may be disposed in the front side of the electronic device, and the image sensor may be at least a part of a back side camera module disposed in the back side of the electronic device.

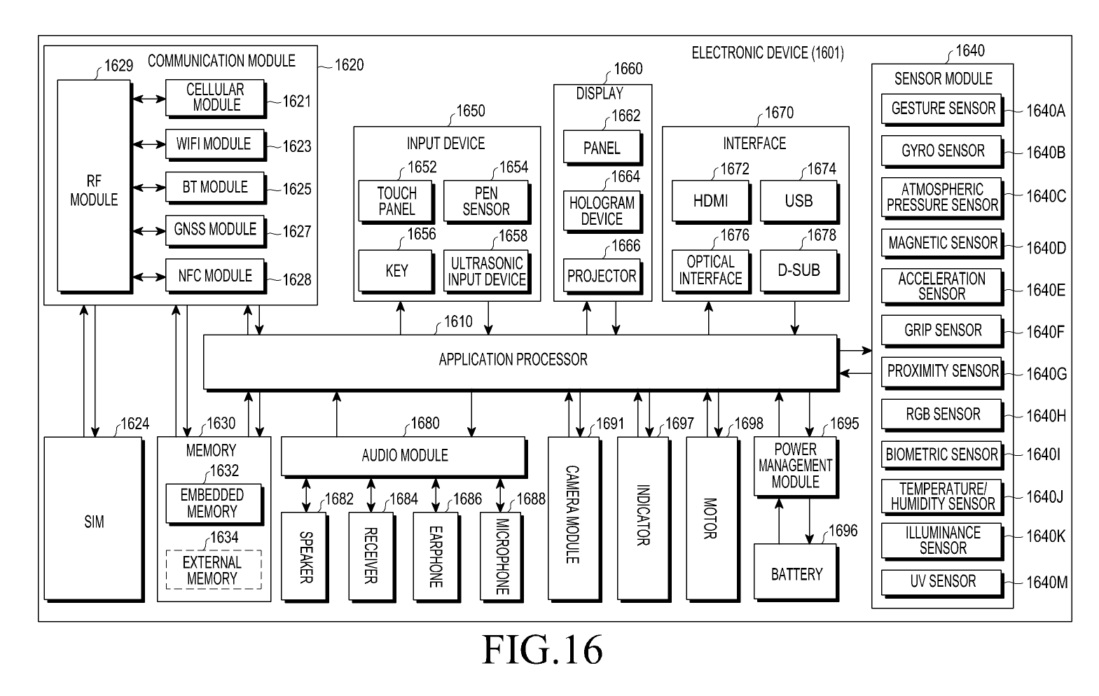

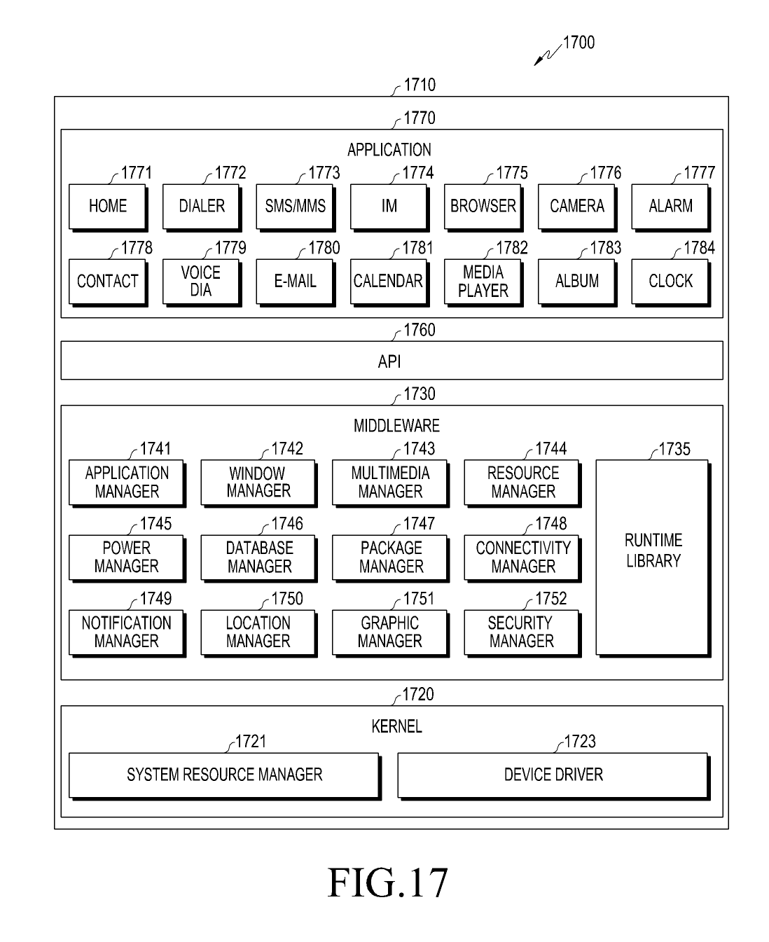

In operation 518, the electronic device may calculate a brightness-related value from the identified or determined color value of each pixel. A method of calculating the brightness-related value from the color value may be embodied using a predetermined conversion table, and a detailed embodiment thereof will be described through the descriptions of FIGS. 16 and 17. In operation 520, the electronic device may identify, determine, or adjust luminance of the display based on the illuminance identified or determined by the illuminance sensor and the brightness-related value identified or determined through the image sensor.

Although various embodiments that determine or adjust the luminance, chroma, or color based on a combination of values sensed by the plurality of sensors have been described in the above descriptions, the following descriptions will provide a process of determining a surrounding brightness environment of the electronic device based on a difference between values sensed by the plurality of sensors, and performing an automatic brightness operation adaptively to the determined surrounding brightness environment.

For example, there is need to take into consideration adjusting the brightness of the display in the state in which a difference in surrounding environment brightness between the front side and the back side from the perspective of the display is high. For example, a user who is in a dark room may use an electronic device in a backlit environment where the back side of the electronic device faces a window corresponding to a light source that is significantly brighter than the room. In the backlit environment, an illuminance sensor installed in a display side of the electronic device may measure illuminance in the direction that faces the user, and the brightness of the display adjusted based on the illuminance value may not provide brightness which is sufficient when the user uses the electronic device in the state in which the line of vision of the user faces the bright window side.

Therefore, the brightness of the display needs to be adjusted by taking into consideration the situation in which the difference in surrounding environment brightness between the front side and the back side of the display is high, such as a backlit environment or the like.

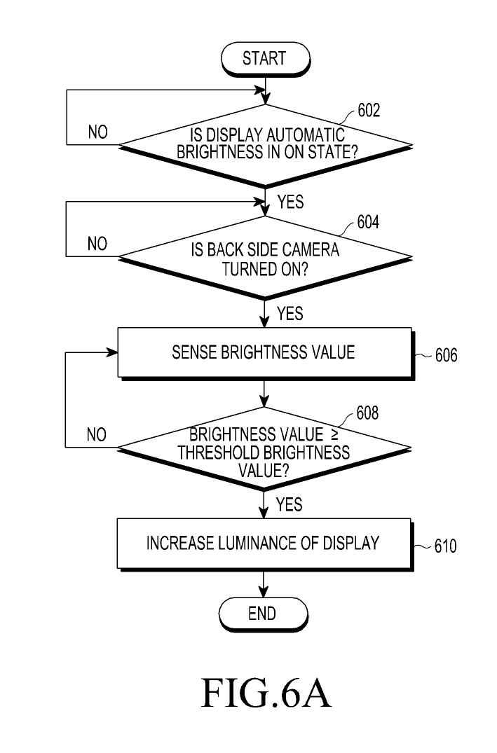

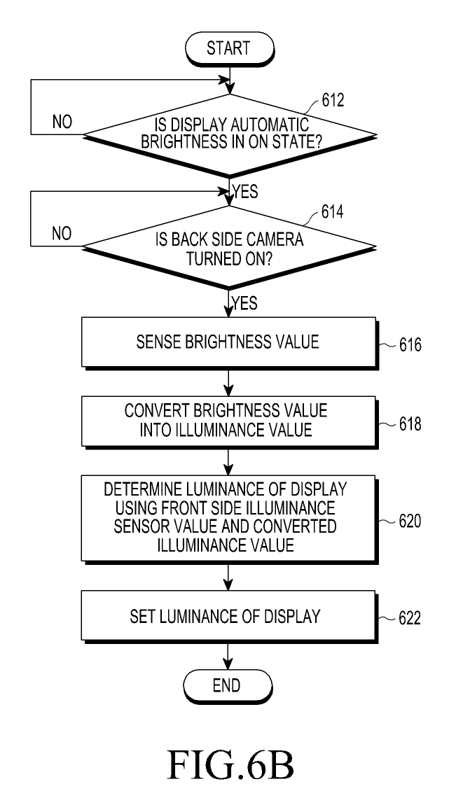

FIG. 6A illustrates a process of automatically adjusting the brightness of a display when the surrounding environment brightness of the front side and the back side of the display is greater than or equal to a threshold value, such as a backlit environment or the like.

FIG. 6A is a flowchart illustrating a procedure of controlling the luminance of a display (e.g., the display 160) under a backlit environment in the state of an automatic brightness operation, by an electronic device (e.g., the processor 120 or the display control module 180) according to various embodiments of the present disclosure.

Referring to FIG. 6A, in operation 602, the electronic device may determine whether display automatic brightness is in the on-state. That is, whether an automatic brightness function of the electronic device, which is to automatically adjust the brightness of the display, is in the on-state. In this instance, when the automatic brightness function of the display is not in the on-state, operation 602 may be performed again. Here, the fact that the automatic brightness function is in the on-state indicates a state in which the brightness of the display is adjusted using an illuminance sensor installed in the front side of the electronic device.

Conversely, the fact that the display automatic brightness is in the on-state in operation 602 indicates a state in which the automatic brightness of the display is adjusted using an illuminance sensor, and the electronic device may determine whether a back side camera is turned on in operation 604. Here, the back side camera may be an image sensor disposed in the back side of the electronic device. When the back side camera is turned on, the electronic device may sense a brightness value (BV) in operation 606. For example, the electronic device may obtain an RGB histogram based on data obtained through the image sensor, and may obtain a brightness value based on the histogram. Accordingly, the electronic device may determine whether a sensed brightness value is greater than or equal to a threshold brightness value in operation 608. Here, the threshold brightness value may be a predetermined threshold value corresponding to a backlit situation. According to an embodiment, the backlit situation may be determined based on a brightness value that is sensed once or a brightness value obtained by periodically sensing at least a predetermined number of times.

As described above, when the sensed brightness value is greater than or equal to the threshold brightness value, it is considered as a backlit situation. When the sensed brightness value is greater than or equal to the threshold value brightness value, the electronic device may increase the luminance of the display based on the sensed brightness value in operation 610. As described above, the electronic device may perform automatic brightness adjustment of the display using an illuminance sensor, that is, the electronic device may adjust the brightness of the display according to a value sensed by the illuminance sensor, and may perform an automatic brightness operation of the display after additionally increasing the luminance of the display when a brightness measurement value obtained using the back side camera is greater than or equal to the threshold brightness value which corresponds to the backlighting or the like. According to an embodiment, an increase by which the luminance of the display is increased may be determined based on a difference between the sensed brightness value and the threshold brightness value.

Although FIG. 6A illustrates the case in which a camera disposed in the back side of the electronic device is in the on state, it may be embodied that an automatic brightness operation is performed by additionally using at least one sensor that is turned on when at least one other sensor different from the camera is turned on.

Although FIG. 6A has described the case in which the electronic device performs a display automatic brightness operation using an illuminance sensor and performs the display automatic brightness operation by additionally using a value sensed by a back side camera, the illuminance sensor and the value sensed by the back side camera may be simultaneously used, which will be described in detail through the description of FIG. 6B.

FIG. 6B is a flowchart illustrating a procedure of controlling the luminance of a display (e.g., the display 160) using an illuminance sensor and an image sensor, by an electronic device (e.g., the processor 120 or the display control module 180) according to various embodiments of the present disclosure.

Referring to FIG. 6B, in operation 612, the electronic device determines whether display automatic brightness is in the on state. In this instance, when a display automatic brightness function is not in the on state, operation 612 may be performed again. When the display automatic brightness is in the on state in operation 612, the electronic device may determine whether the back side camera is turned on in operation 614. Here, the back side camera may be an image sensor disposed in the back side of the electronic device, and, when the back side camera is turned on, the electronic device may sense a brightness value (BV) using the back side camera in operation 616. Subsequently, the electronic device may convert the brightness value into an illuminance value in operation 618, and may determine the luminance of the display for adjustment based on a sensor value of the illuminance sensor installed in the front side of the electronic device and the converted illuminance value in operation 620. That is, the electronic device may obtain a value by which the luminance is to be adjusted using the sensor value of the illuminance sensor and the sensor value of the back side camera. In this instance, to determine the value by which the luminance is to be adjusted, predetermined table values to which illuminance values (e.g., a converted illuminance value and a sensor value of the illuminance sensor) and luminance adjustment values are mapped, a predetermined function, and the like. Accordingly, in operation 622, the electronic device may set the luminance of the display based on the luminance of the display determined in operation 620.

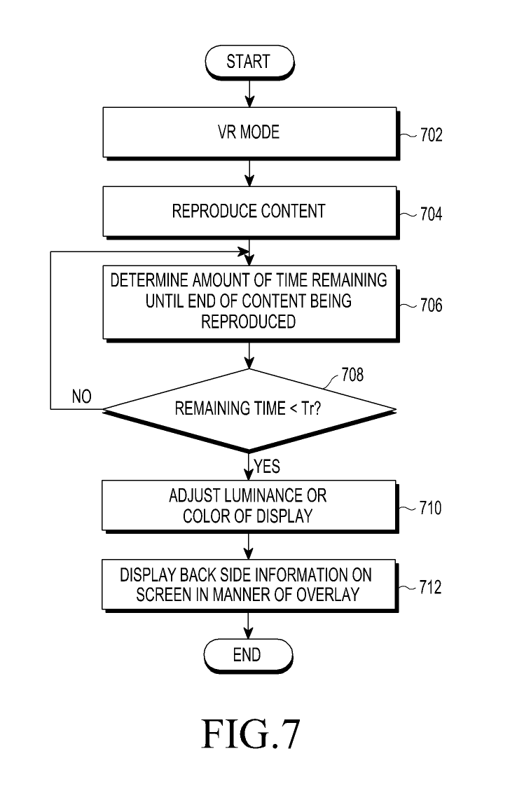

FIG. 7 is a flowchart illustrating a procedure of controlling a display (e.g., the display 160) based on content, by an electronic device (e.g., the processor 120 or the display control module 180). For example, this is a flowchart illustrating a procedure of controlling the display by taking into consideration a reproduction time of content by an electronic device.

Referring to FIG. 7, the electronic device operates in a virtual reality (VR) mode in operation 702, and reproduces VR-related content in operation 704. A user is disconnected from the external environment in the VR mode, and may be in a relatively dark state. However, when the VR mode is terminated, it is instantly converted to a bright state, whereby the eyes of the user may not adapt to the state.

According to various embodiments of the present disclosure, in operation 706, the electronic device may determine the amount of time remaining until the termination of the reproduction of the VR-related content or a ratio of the amount of remaining time to the entire amount of time. When the ratio of the amount of remaining time to the entire amount time is less than or equal to a predetermined threshold value (Tr) in operation 708, the electronic device may adjust the luminance, chroma, or color of the display in operation 710.

Also, according to various embodiments of the present disclosure, when the VR-related content is terminated, back side information of the electronic device may be displayed on a screen in an overlay manner in operation 712, as illustrated in FIG. 18, such that the user can adapt to a sudden change in an environment. The back side information displayed in an overlay manner may be set to be brighter gradually as a point in time when the VR-related content is to be terminated becomes closer.

According to various embodiments of the present disclosure, at least one operation may be omitted from the operations of FIGS. 3 to 7 or at least one other operation may be added to the operations. In addition, the operations of FIGS. 3 to 7 may be processed in order of the flowchart, or the order of at least one operation may be changed with the order of another operation. Also, the operations of FIGS. 3 to 7 may be performed in an electronic device, or may be performed in a server. Also, it is embodied that at least one of the operations illustrated in FIGS. 3 to 7 may be performed in an electronic device, and the remaining operations may be performed in a server.

In an operation method of an electronic device according to any one of the various embodiments of the present disclosure, a display control method of the electronic device may include: displaying content by a display installed in a first side of the electronic device; sensing incident light by a sensor installed in a second side of the electronic device; determining brightness information around the electronic device at least based on the sensed light; and adjusting at least one property of the display or at least one property of the content at least based on the brightness information.

According to various embodiments of the present disclosure, when another brightness information, which is determined based on light sensed by another sensor for sensing light incident to the first side, belongs to a designated range, the method performs the above described determination.

According to various embodiments of the present disclosure, the method performs the above described adjustment further based on another brightness information, which is determined based on light sensed through another sensor for sensing light incident to the first side.

According to various embodiments of the present disclosure, the method performs: determining whether a predetermined condition for adjusting the property of the display is satisfied; and processing data received from the first sensor or the second sensor when the predetermined condition is satisfied.

According to various embodiments of the present disclosure, the predetermined condition is determined based on at least one of display state information of the electronic device, information related to movement of the electronic device, surrounding environment information of the electronic device, and information related to a cover attached to the electronic device.

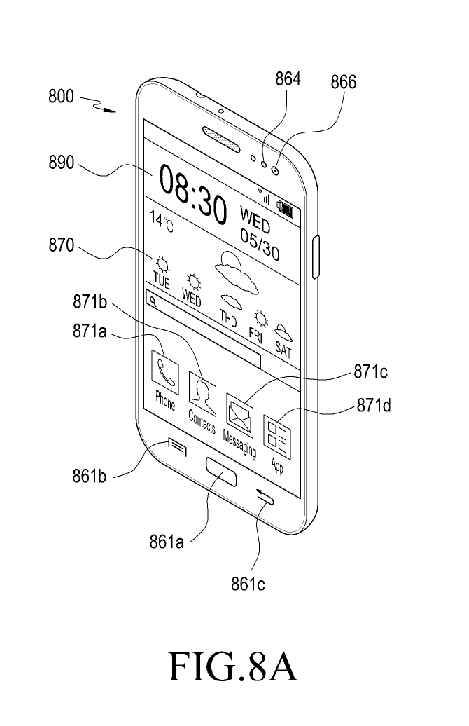

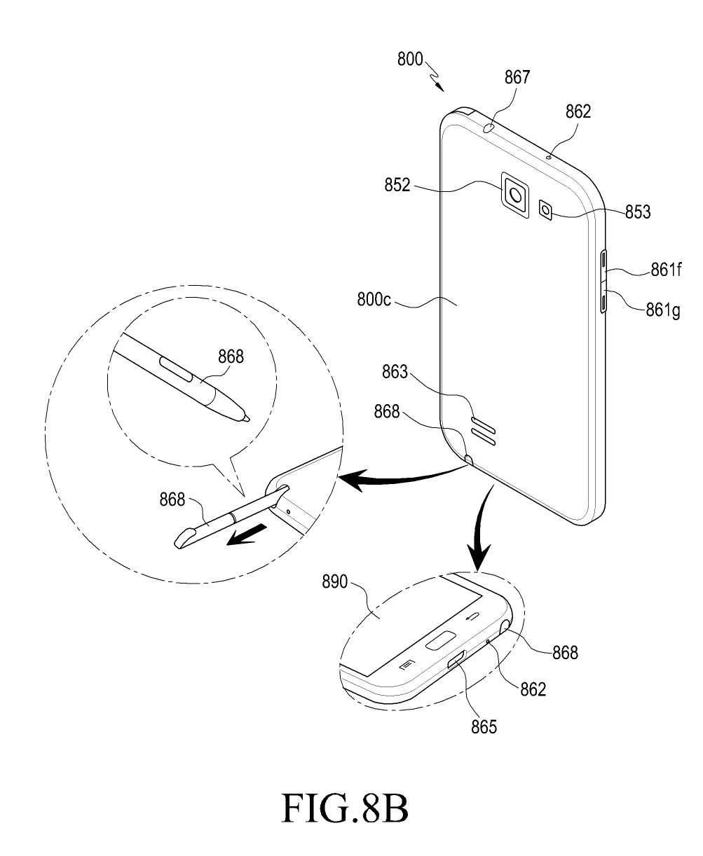

FIGS. 8a and 8b are perspective views of an electronic device in which sensors according to various embodiments of the present disclosure are disposed. FIG. 8A is a front perspective view of an electronic device according to various embodiments of the present disclosure, and FIG. 8B is a back perspective view of an electronic device according to various embodiments of the present disclosure.

Referring to FIGS. 8A and 8B, a touch screen 890 may be disposed in the center of the front side of the electronic device 800. The touch screen 890 may be formed to be large such that the touch screen 890 occupies most of the front side of the electronic device 800. FIG. 8A illustrates an example in which a main home screen is displayed on the touch screen 890. The main home screen may include a first screen displayed on the touch screen 890 when the power of the electronic device 800 is turned on. Also, when the electronic device 800 has many pages of different home screens, the main home screen may be a first home screen among the many pages of the home screens. On the home screen, short-cut icons 871a 871b, or 871c for executing frequently used applications, a main menu switch key 871d, time, weather 870, or the like may be displayed. The main menu switch key 871d may display a menu screen on the touch screen 890. Also, a status bar indicating the state of the electronic device 800, such as a battery charging state, the intensity of a received signal, the current time, or the like may be displayed in an upper portion of the touch screen 890.

A home button 861a, a menu button 861b, and a back button 861c may be formed in a lower portion of the touch screen 890.

The home button 861a may enable the main home screen to be displayed on the touch screen 890. For example, when the home key 861a is touched in the state in which another home screen (any home screen), which is different from the main home screen, or a menu screen is displayed, the main home screen may be displayed on the touch screen 890. Also, when the home button 861a is touched while applications are executed on the touch screen 890, the main home screen of FIG. 8A may be displayed on the touch screen 890. Also, the home button 861a may be used to display recently used applications or a task manager on the touch screen 890.

The menu button 861b provides a connection menu which may be used on the touch screen 890. The connection menu may include a widget addition menu, a background screen changing menu, a search menu, an editing menu, a configuration setup menu and the like.

The back button 861c may display a screen which was executed immediately before a currently executed screen, or may terminate the most recently used application.

A first camera 866 (e.g., a first image sensor), an illuminance sensor 864, and/or a proximity sensor may be disposed in the edge of the front side of the electronic device 800. A second camera 852 (e.g., a second image sensor), a flash 853, a speaker 863 may be disposed in the back side 800c of the electronic device 800.

According to various embodiments of the present disclosure, the electronic device 800 may include a housing forming at least a part of the external surface of the electronic device 800, and at least one sensor (e.g., the first camera 866, the second camera 852, the illuminance sensor 864, the proximity sensor, or the like) form at least a part of the housing.

Also, the sensor may be located between the display and the housing.

In a lateral side of the electronic device 800, for example, a power/reset button, a volume button 861f and 861g, a terrestrial DMB antenna for receiving broadcasting, one or more microphones 862, or the like may be disposed. The DMB antenna may be fixed to the electronic device 800, or may be formed to be detachable from the electronic device 800.

Also, a connector 865 may be formed in the bottom lateral side of the electronic device 800, and an electronic pen 868 may be inserted into the bottom lateral side. A plurality of electrodes is formed in the connector 865, and may be wiredly connected to an external device. An earphone connection jack 867 may be formed in the top lateral side of the electronic device 800. An earphone may be inserted into the earphone connecting jack 867.

Although FIGS. 8A and 8B illustrate that one camera (an image sensor) is disposed in each of the front side and the back side of the electronic device 800, and one illuminance sensor is disposed in the front side, image sensors or illuminance sensors may be embodied by variously changing the number of image sensors or illuminance sensors and/or positions thereof.

According to various embodiments of the present disclosure, the electronic device may be embodied in various types, such as a wrap-around type, a full front display type (e.g., a type in which the front side is formed as a display, and a no bezel or a minimized bezel is included), a transparent device type, or the like, and the various embodiments of the present disclosure may not be limited to a predetermined type of electronic device.

Also, according to various embodiments of the present disclosure, when the electronic device is a transparent display type or a full front display type, the color of the display may be changed or adjusted based on color information of the surface of a floor when the electronic device is put down on the floor.

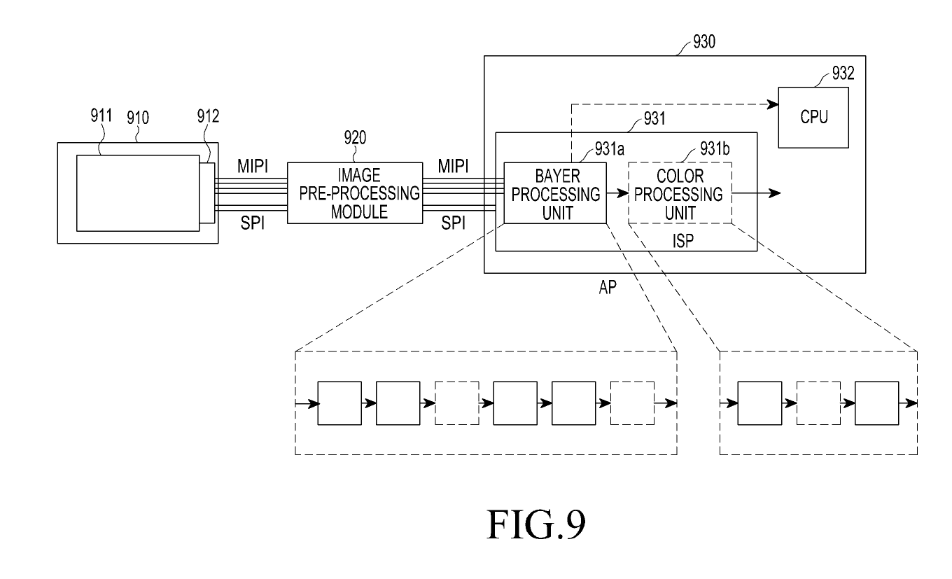

FIG. 9 is a block diagram illustrating a configuration of an image processing device according to various embodiments of the present disclosure. Referring to FIG. 9, an image processing device according to various embodiments of the present disclosure may be configured to include an image sensor module 910, an image pre-processing module 920 (e.g., a companion chip), and an application processor (AP) 930. The image processing device may be configured such that the image sensor module 910 and the application processor 930 are directly connected without the image pre-processing module 920.

The image sensor module 910 is, for example, a module for sensing an image, and may transmit each sensed pixel value to the image pre-processing module 920 or the application processor 930 through a mobile industry processor interface (MIPI) line. Also, the image sensor module 910 may transmit and receive various control signals through a serial peripheral interface (SPI) or an inter integrated circuit (I2C). The image sensor module 910 may be embodied to include an image sensor 911 (e.g., a CMOS sensor) and a control logic 912. The image sensor 911 may be embodied as a complementary metal oxide semiconductor (CMOS), and may sense an image by receiving and outputting a signal based on each pixel unit. The control logic 912 may perform a function of controlling driving of the image sensor module 910.

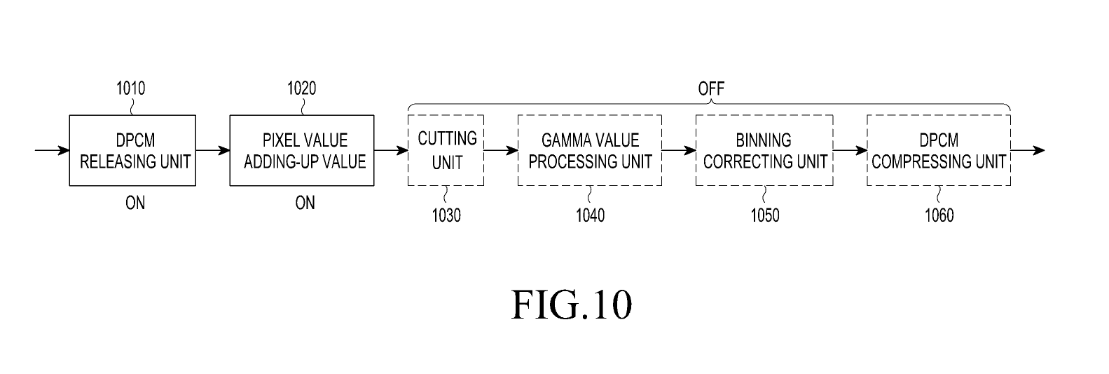

The image pre-processing module 920 may be additionally included in order to support, for example, a predetermined function of an image sensor. For example, the image pre-processing module 920 may perform pre-processing for improving the picture quality of an image, and the detailed example thereof will be provided through the description associated with FIG. 10.

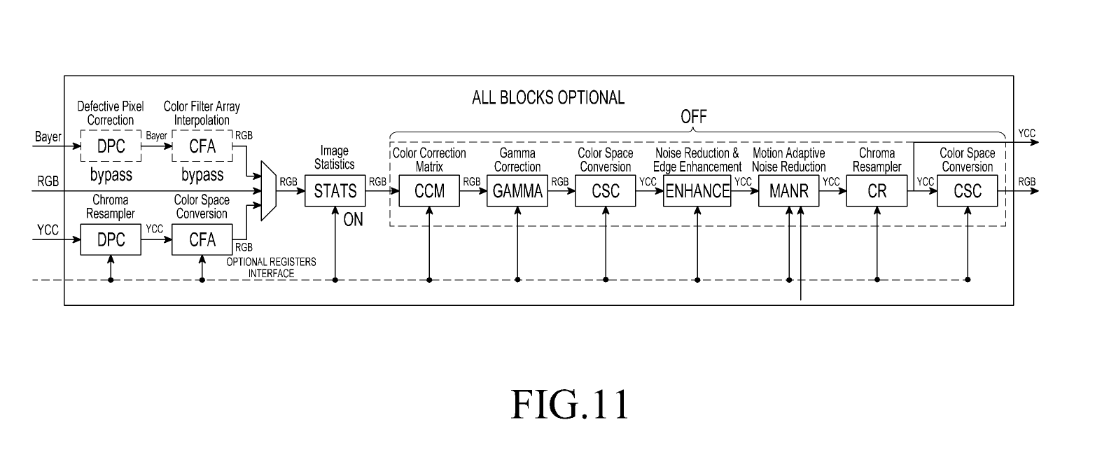

The application processor 930 may be configured to include, for example, an image signal processing unit (image signal processor (ISP)) 931 and a central processing unit (CPU) 932. The image signal processing unit 931 may be configured to include, for example, a Bayer processing unit 931a and/or color processing unit 931b (Luma/Color), or the like. Also, the Bayer processing unit 931a or the color processing unit 931b may be configured in the form of a pipeline in which a plurality of processing blocks are included for each processing function. The detailed embodiment of the image signal processing unit 931 is illustrated in FIG. 11.

Referring to FIG. 9, according to various embodiments of the present disclosure, data for determining luminance, chroma, or color may be obtained from an image sensor installed in the back side of the electronic device. For example, data (e.g., an RGB histogram, an exposure time, or the like) for determining luminance, chroma, or color may be obtained using data processed by at least a part of the image signal processing unit 931 of FIG. 9.

For example, according to various embodiments of the present disclosure, information (e.g., RGB histogram, an exposure time, or the like) obtained from some blocks during a processing process of the Bayer processing unit 931a may be stored in a memory. A processor (e.g., CPU 932) may obtain a brightness-related value (e.g., illuminance value) using a result stored in the memory.

According to various embodiments of the present disclosure, to reduce the amount of power consumed when the brightness-related value is obtained, only a processing block related to obtaining the data is turned on from among a plurality of blocks included in an internal pipeline of the image signal processing unit and the remaining irrelevant processing blocks may be turned off or may be bypassed in the pipeline. For example, blocks drawn by a solid line from among a plurality of blocks included in the Bayer processing unit 931a may be turned on, and the remaining blocks drawn by a broken line may be off or may be bypassed. Also, blocks drawn by a solid line from among a plurality of blocks included in the color processing unit 931b may be turned on, and the remaining blocks drawn by a broken line may be turned off or may be bypassed.

A value obtained or output from the Bayer processing unit 931a may include an accumulated pixel value (e.g., an accumulated RGB pixel value), an RGB histogram, or the like. The color processing unit 931b may perform a function of processing the brightness or color of a sensed image.

Also, according to various embodiments of the present disclosure, only a processing block related to obtaining the data is turned on from among a plurality of blocks included in an internal pipeline of the image pre-processing module 920 and the remaining irrelevant processing blocks may be turned off or may be bypassed in the pipeline. The detailed example thereof will be described through the description associated with FIG. 10.

According to various embodiments, an electronic device (e.g., the processor 120 or the controller 220) may be embodied to turn off high-speed data communication (e.g., MIPI) which sends pixel information from the image sensor module 910 to the image pre-processing module 920, and to operate only a control signal line (e.g., SPI).

Also, according to various embodiments, information (e.g., an RGB histogram, an exposure time, or the like) obtained from an ISP 931 of an AP 930 may be stored in a memory (e.g., the storage unit 240). The CPU 932 may calculate back side information using a result stored in the memory. To reduce the amount of power consumed when information obtained from the ISP 931 of the AP 930 is stored in the memory, only a related block may be operated in an internal pipeline of the ISP 931, and the remaining blocks may be turned off or may be bypassed.

FIG. 10 is a diagram illustrating detailed blocks of an image pre-processing module according to various embodiments of the present disclosure. Referring to FIG. 10, the image pre-processing module of FIG. 9 may include at least one of a differential pulse code modulation (DPCM) releasing unit 1010, a pixel value adding-up unit 1020, a cutting unit 1030, a gamma value processing unit 1040, a binning correcting unit 1050, and a DPCM compressing unit 1060. As described above, according to various embodiments of the present disclosure, in order to obtain a brightness-related value based on information obtained from an image sensor, only at least a part of a plurality of blocks of the image pre-processing module may be used.

For example, the DPCM releasing unit 1010 and the pixel value adding-up unit 1020 are turned on, and the cutting unit 1030, the gamma value processing unit 1040, the binning correcting unit 1050, and the DPCM compressing unit 1060 may be turned off or bypassed.

FIG. 11 is a diagram illustrating detailed blocks of the image signal processing unit 931 according to various embodiments of the present disclosure. Referring to FIG. 11, only at least a part of a plurality of blocks included in an image signal processing unit (e.g., a defective pixel correction (DPC) unit for YCC, a color filter array (CFA) interpolation unit, an STATS unit (image statistics unit), or the like are turned on, and the remaining blocks are turned off or bypassed (e.g., a DPC unit for Bayer, a CFA unit, a color correction matrix (CCM) unit, a gamma correction unit, a color space conversion (CSC) unit, an enhancement unit (noise reduction and edge enhancement unit), a motion adaptive noise reduction (MANR) unit, a chroma resampler (CR) unit, a color space conversion (CSC) unit, or the like).

For example, the CCM unit is a module for correcting variation in color of an image, which occurs due to an optical reason, a lighting variable, the characteristic of a color filter of a sensor, or the like. The gamma unit is a module for correcting a gamma value. The enhancement unit is a module for reducing noise or improving edge. Also, the MANR unit is a module for reducing noise adaptively to a movement. The CSC unit is a module for converting a color space. The CR unit is a module for converting an YcbCr input into a desired chroma sub-sampling format.

The configuration of the image signal module unit of FIG. 11 is an example of an image signal module unit to which an embodiment of the present disclosure may be applied, and embodiments of the present disclosure may be applied to variously configured image signal module units. For example, at least one processing block (e.g., module or element) from among a plurality of detailed processing blocks included in the image signal module unit may be turned off or bypassed.

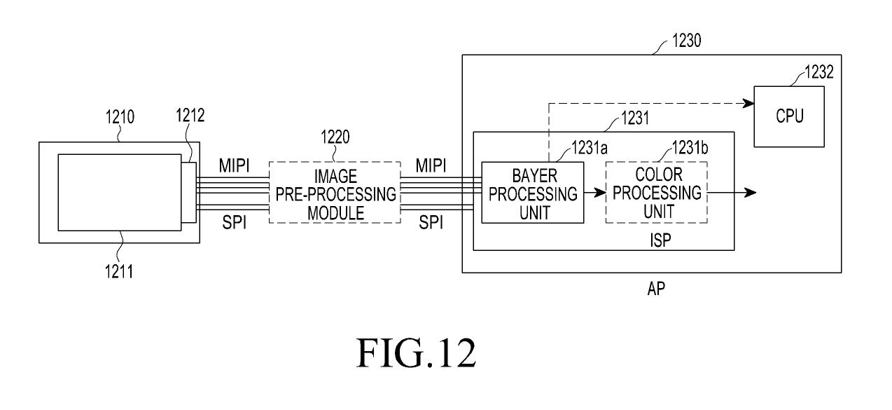

Hereinafter, referring to FIGS. 12 to 15, various embodiments that obtain information related to brightness using at least some elements of the image processing device of FIG. 9 will be described.

FIG. 12 is a block diagram illustrating a configuration of an image processing device according to various embodiments of the present disclosure. Referring to FIG. 12, an image processing device according to various embodiments of the present disclosure may be configured to include an image sensor module 1210, an image pre-processing module 1220 (e.g., a companion chip), and an application processor (AP) 1230. The image processing device may be configured such that the image sensor module 1210 and the application processor 1230 are directly connected without the image pre-processing module 1220.

The image sensor module 1210 is a module for sensing an image, and may transmit each sensed pixel value to the image pre-processing module 1220 or the application processor 1230 through an MIPI line. Also, the image sensor module 1210 may transmit and receive various control signals through an SPI or an I2C. The image sensor module 1210 may be embodied to include an image sensor 1211 (e.g., a CMOS sensor) and a control logic 1212.

The image pre-processing module 1220 may be additionally included in order to support a predetermined function of an image sensor. For example, the image pre-processing module 1220 may perform pre-processing for improving the picture quality of an image.

The application processor 1230 may be configured to include an image signal processing unit (ISP) 1231 and a central processing unit (CPU) 1232. The image signal processing unit 1231 may be configured to include a Bayer processing unit 1231a and a color processing unit 1231b (Luma/Color), or the like. Also, the Bayer processing unit 1231a or the color processing unit 1231b may be configured in the form of a pipeline in which a plurality of processing blocks are included for each processing function. The detailed embodiment of the image signal processing unit 1231 is illustrated in FIG. 11. Basic functions of each element have been described in the description of FIG. 9 and thus, repeated descriptions will be omitted.

Referring to FIG. 12, according to various embodiments of the present disclosure, the image pre-processing module 1220 may be capable of obtaining data related to brightness. For example, the image pre-processing module 1220 may obtain the data related to brightness from the Bayer processing unit 1231a of the application processor (AP) 1230. The image pre-processing module 1220 may extract a Bayer histogram from the Bayer processing unit 1231a, and may directly transfer the same to the central processing unit (CPU) 1232 of the application processor (AP) 1230. Also, according to various embodiments of the present disclosure, the image pre-processing module 1220 may extract a Bayer histogram from the Bayer processing unit 1231a, may calculate data related to brightness, white balance, or the like using the extracted Bayer histogram, and may transfer the calculation result to the central processing unit (CPU) 1232 of the application processor (AP) 1230.

According to various embodiments of the present disclosure, at least a part of blocks included in the ISP 1231 of the AP 1230 may be turned off to reduce the amount of power consumed when information obtained from the image sensor module 1210 is processed.

Also, according to various embodiments, an electronic device (e.g., the processor 120 or the controller 220) may be embodied to turn off high-speed data communication (e.g., MIPI) which sends pixel information from the image sensor module 1210 to the image pre-processing module 1220, and to operate only a control signal line (e.g., SPI).

Also, according to various embodiments, information (e.g., an RGB histogram, an exposure time, or the like) obtained from the ISP 1231 of the AP 1230 may be stored in a memory (e.g., the storage unit 240). The CPU 1232 may calculate back side information using a result stored in the memory. To reduce the amount of power consumed when information obtained from the ISP 1231 of the AP 1230 is stored in a memory, only a related block may be operated in an internal pipeline of the ISP 1231, and the remaining blocks may be turned off or bypassed.

The central processing unit (CPU) 1232 of the application processor (AP) 1230 may calculate or process data related to brightness based on information transferred from the image pre-processing module 1220.

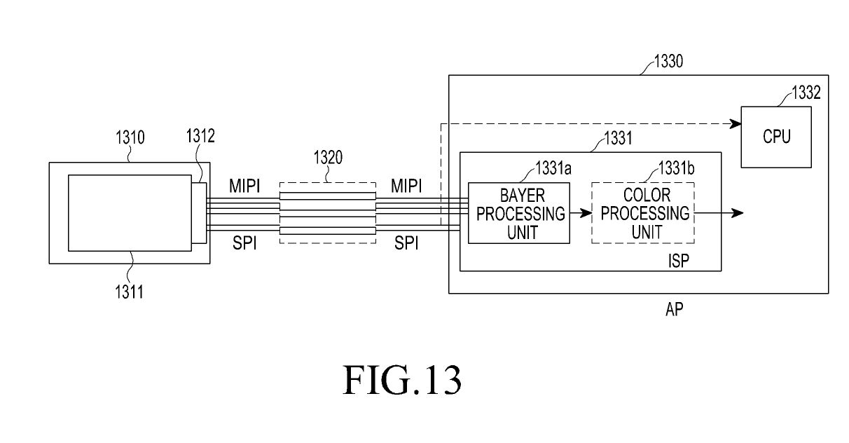

FIG. 13 is a block diagram illustrating a configuration of an image processing device according to various embodiments of the present disclosure. Referring to FIG. 13, an image processing device according to various embodiments of the present disclosure may be configured to include an image sensor module 1310, an image pre-processing module 1320 (e.g., a companion chip), and an application processor (AP) 1330. The image processing device may be configured such that the image sensor module 1310 and the application processor 1330 are directly connected without the image pre-processing module 1320.

The image sensor module 1310 is a module for sensing an image, and may transmit each sensed pixel value to the image pre-processing module 1320 or the application processor 1330 through an MIPI line. Also, the image sensor module 1310 may transmit and receive various control signals through an SPI or an I2C. The image sensor module 1310 may be embodied to include an image sensor 1311 (e.g., a CMOS sensor) and a control logic 1312.

The image pre-processing module 1320 may be additionally included in order to support a predetermined function of an image sensor. For example, the image pre-processing module 1320 may perform pre-processing for improving the picture quality of an image.

The application processor 1330 may be configured to include an image signal processing unit (ISP) 1331 and a central processing unit (CPU) 1332. The image signal processing unit 1331 may be configured to include a Bayer processing unit 1331a and a color processing unit 1331b (Luma/Color), or the like. Also, the Bayer processing unit 1331a or the color processing unit 1331b may be configured in the form of a pipeline in which a plurality of processing blocks are included for each processing function. The detailed embodiment of the image signal processing unit 1331 is illustrated in FIG. 11. Basic functions of each element have been described in the description of FIGS. 9 and 13, and thus, repeated descriptions will be omitted.

According to various embodiments of the present disclosure, desired information may be obtained by operating only at least a part of the functional blocks of the image pre-processing module 1320 in order to reduce the amount of power consumed by the image processing device. For example, it may be embodied that a high-speed data communication line (e.g., MIPI) for transmitting pixel information between modules is turned off, and only a control line (e.g., an SPI or I2C) is operated.

As a concrete example, as described in FIG. 10, from among a plurality of functional blocks included in the image pre-processing module 1320, the DPCM releasing unit 1010 and the pixel value adding-up unit 1020 may be turned on, and the cutting unit 1030, the gamma value processing unit 1040, the binning correcting unit 1050, and the DPCM compressing unit 1060 may be turned off or bypassed.

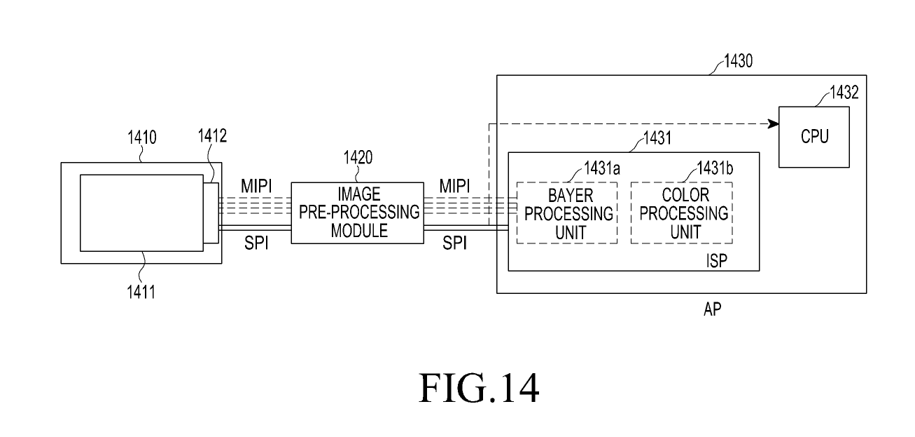

FIG. 14 is a block diagram illustrating a configuration of an image processing device according to various embodiments of the present disclosure. Referring to FIG. 14, an image processing device according to various embodiments of the present disclosure may be configured to include an image sensor module 1410, an image pre-processing module 1420 (e.g., a companion chip), and an application processor (AP) 1430. The image processing device may be configured such that the image sensor module 1410 and the application processor 1430 are directly connected without the image pre-processing module 1420.

According to various embodiments of the present disclosure, in the image sensor module 1410, an image sensor 1411 senses an image and a control logic 1412 directly generates information such as data related to brightness, white balance, or the like from information sensed by the image sensor 1411.

The data related to brightness or white balance information generated from the image sensor module 1410 may be transmitted to the application processor (AP) 1430 through the image pre-processing module 1420.

The application processor (AP) 1430 may be configured to include an image signal processing unit (ISP) 1431 and a central processing unit (CPU) 1432. The image signal processing unit 1431 may be configured to include a Bayer processing unit 1431a, a color processing unit 1431b (Luma/Color), and the like. Basic functions of each element have been described in the description of FIGS. 9 and 13, and thus, repeated descriptions will be omitted.

In the example of FIG. 14, data is directly generated in the image sensor module 1410 and thus, data information on each pixel may not need to be transmitted through an MIPI line. Therefore, the MIPI line is turned off, and data generated from the image sensor module 1410 may be transmitted to the central processing unit (CPU) 1432 of the application processor (AP) 1430 through only an SPI or I2C line.

For example, the image pre-processing module 1420 may identify or determine back side information (e.g., brightness, white balance, or the like) from information (e.g., a Bayer histogram, an accumulated RGB value, or the like) obtained from the image sensor module 1410, and may transfer the same to the application processor (AP) 1430.

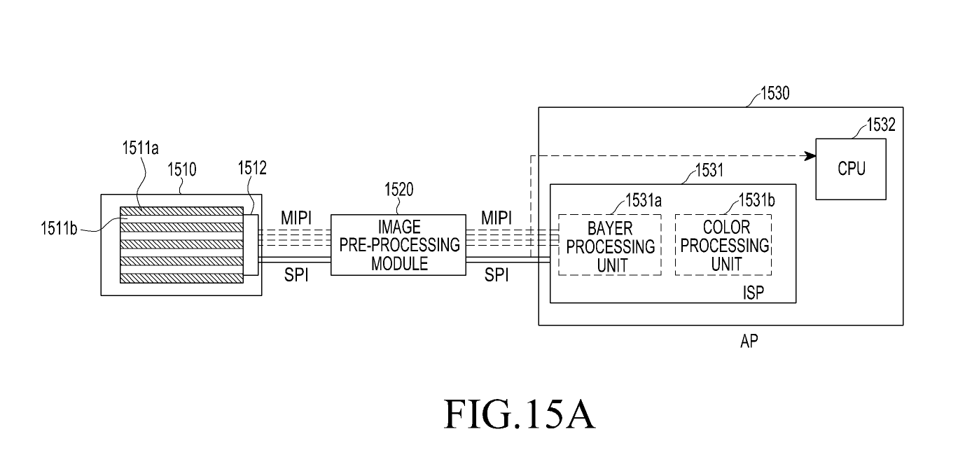

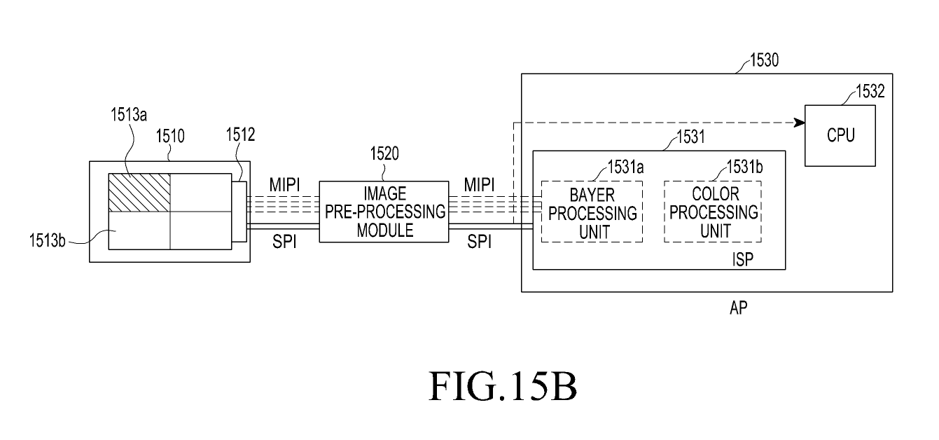

According to various embodiments of the present disclosure, at least some functions of the image pre-processing module 1420 and the ISP 1431 may be turned off in order to reduce the amount of power consumed. Also, functional blocks excluding an image sensor, such as an actuator of the image sensor module 1410, an optical image stabilization (OIS), and the like may be turned off or bypassed. Also, According to various embodiments of the present disclosure, it may be embodied that only some scan lines of the image sensor module 1410 are operated as illustrated in FIGS. 15a and 15b in order to reduce the amount of power consumed.

FIGS. 15a and 15b are block diagrams illustrating configurations of an image processing device according to various embodiments of the present disclosure. Referring to FIGS. 15a and 15b, an image processing device according to various embodiments of the present disclosure may be configured to include an image sensor module 1510, an image pre-processing module 1520 (e.g., a companion chip), and an application processor (AP) 1530. The image processing device may be configured such that the image sensor module 1410 and the application processor 1530 are directly connected without the image pre-processing module 1520.

According to various embodiments of the present disclosure, in the image sensor module 1510, an image sensor 1511 senses an image and a control logic 1512 directly generates information such as data related to brightness, white balance, or the like from information sensed by the image sensor 1511.

The data related to brightness or white balance information generated from the image sensor module 1510 may be transmitted to the application processor (AP) 1520 through the image pre-processing module 1530.

In the embodiments of FIGS. 15a and 15b, data is directly generated in the image sensor module 1510 and thus, data information on each pixel may not need to be transmitted through an MIPI line. Therefore, the MIPI line is turned off, and data generated from the image sensor module 1510 may be transmitted to a central processing unit (CPU) 1532 of the application processor (AP) 1530 through only an SPI or I2C line.

The application processor (AP) 1530 may be configured to include an image signal processing unit (ISP) 1531 and the central processing unit (CPU) 1532. The image signal processing unit 1531 may be configured to include a Bayer processing unit 1531a, a color processing unit 1531b (Luma/Color), and the like. Basic functions of each element have been described in the description of FIGS. 9 and 13, and thus, repeated descriptions will be omitted.

Referring to FIGS. 15a and 15b, according to various embodiments of the present disclosure, the image signal processing unit 1510 directly generates information related to brightness, and may not use information on each pixel, whereby the image signal processing unit 1510 may generate information associated with brightness using only a partial pixel area, instead of using the entire area of the image sensor 1511.

For example, the information related to brightness may be generated using only values sensed from pixels in even-numbered lines or odd-numbered lines, which are alternately arranged horizontally or vertically as illustrated in FIG. 15a. Alternatively, as illustrated in FIG. 15b, the entire area of the image sensor 1511 may be divided into a plurality of areas 1513a and 1513b, and information associated with brightness may be generated using a value sensed from at least one area 1513a of the plurality of areas.

According to various embodiments, the electronic device (e.g., the processor 120 or the controller 220) may generate (determine) data related to brightness or white balance information using only some pixels from among a plurality of unit pixels (e.g., red, green, or blue) included in the image sensor module 1510. For example, the electronic device (e.g., the controller 220) may determine data related to brightness (e.g., brightness information) or white balance information using the attribute (e.g., color information) of pixels that occupy the largest portion of the unit pixels included in the image sensor module 1510 (e.g., the image sensor 1411). For example, when the number of unit pixels having an attribute of green is greater than the number of pixels having an attribute of red or blue, the image sensor module 1510 (e.g., the image sensor 1411) may determine brightness or white balance information using image information (e.g., color information) of the unit pixel having an attribute of green. The electronic device (e.g., the controller 220) may drive some pixels (e.g., green pixels) of the control logic 1512 so as to reduce the amount of power consumed by the electronic device when determining brightness or white balance.

According to various embodiments, an electronic device (e.g., the processor 120 or the controller 220) may determine data related to brightness (e.g., brightness information) or white balance information using one or more pixels, the number of which is the smallest from among a plurality of pixels. For example, when the amount of power consumed by the electronic device is greater than or equal to a designated number (e.g., greater than or equal to 80% of the total amount of power consumed by the image sensor module 1510), the electronic device (e.g., the controller 220) may determine brightness information using color information of pixels, the number of which is the smallest from among the pixels included in the image sensor module 1510 (e.g., the image sensor 1411). For example, when the number of pixels having an attribute of red or blue is smaller than the number of pixels having an attribute of green, one color information of unit pixels having an attribute of red or blue may be selected and brightness information or white balance information may be determined based on the selected color information of the unit pixel. The electronic device (e.g., the controller 220) may drive some pixels (e.g., red or blue pixels) of the control logic 1512 to reduce the amount of power consumed by the electronic device when determining brightness or white balance information.

According to various embodiments, when unit pixels, the number of which is the smallest among a plurality of pixels, include more than one piece of color information, color information used for determining brightness information or white balance information may be determined based on a priority previously set in the electronic device. For example, when a pixel having an attribute of red has a high priority over pixels having an attribute of red or blue, the electronic device (e.g., the controller 220) may determine brightness information or white balance information using the pixel having the attribute of red. The predetermined priority may be changed based on the amount of light incident to the image sensor module 1510. For example, the electronic device (e.g., the controller 220) may compare the amount of light incident to the image sensor module 1510 for each unit pixel, and may change a priority to be used for determining the brightness information or white balance information, based on the comparison result. For example, when the amount of light of a red pixel (e.g., a pixel having an attribute of red) is greater than the amount of light of a blue pixel (e.g., when the amount of light with an attribute of red is greater than the amount of light with an attribute of blue), the priority of the red pixel may be set to be higher than the priority of the blue pixel.

Also, according to various embodiments, illuminance may be determined from color information using an illuminance conversion table for an RGB sensor value according to various embodiments of the present disclosure. For example, an illuminance value corresponding to color information sensed by an RGB sensor may be determined using a table in which illuminance values corresponding to RGB sensor values are included. Also, when the environment of a lighting, such as a light bulb or a fluorescent light, is unusual, illuminance may be determined adaptively to the current lighting environment, through information sensed by at least one sensor.

FIG. 16 is a block diagram of an electronic device 1601 according to various embodiments. For example, the electronic device 1601 may include a part or the entirety of the electronic device 101 illustrated in FIG. 1. The electronic device 1601 may include one or more processors (e.g., application processor (AP)) 1610, a communication module 1620, a subscriber identification module 1624, a memory 1630, a sensor module 1640, an input device 1650, a display 1660, an interface 1670, an audio module 1680, a camera module 1691, a power management module 1695, a battery 1696, an indicator 1697, and a motor 1698.

The processor 1610 may control multiple hardware or software elements connected to the processor 1610 by running, for example, an Operation System (OS) or an application program, and may process various data and execute operations. The processor 1610 may be embodied, for example, as a System on Chip (SoC). According to an embodiment, the processor 1610 may further include a graphic processing unit (GPU) and/or an image signal processor. The processor 1610 may include at least a part (e.g., a cellular module 1621) of the elements illustrated in FIG. 2. The processor 1610 loads a command or data received from at least one (e.g., a non-volatile memory) of other elements in a volatile memory, processes the command or data, and stores resultant data in a non-volatile memory.

The communication module 1620 may have a configuration identical or similar to that of the communication interface 170 illustrated in FIG. 1. The communication module 1620 may include, for example, a cellular module 1621, a Wi-Fi module 1623, a BT module 1625, a GNSS module 1627 (e.g., a GPS module, a Glonass module, a Beidou module, or a Galileo module), an NFC module 1628, and a radio frequency (RF) module 1629.

The cellular module 1621 may provide, for example, a voice call, a video call, a text message service, an Internet service, or the like through a communication network. According to an embodiment, the cellular module 1621 may distinguish and authenticate the electronic device 1601 in a communication network using a subscriber identification module (e.g., a SIM card) 1624. According to an embodiment, the cellular module 1621 may perform at least some of the functions that the processor 1610 may provide. According to an embodiment, the cellular module 1621 may include a communication processor (CP).

Each of the Wi-Fi module 1623, the Bluetooth module 1625, the GNSS module 1627, or the NFC module 1628 may include, for example, a processor that processes data transmitted and received through a corresponding module. According to an embodiment, at least some (e.g., two or more) of the cellular module 1621, the Wi-Fi module 1623, the Bluetooth module 1625, the GNSS module 1627, and the NFC module 1628 may be included in one integrated chip (IC) or IC package.

The RF module 1629 may transmit and receive, for example, a communication signal (e.g., an RF signal). The RF module 1629 may include, for example, a transceiver, a power amplifier module (PAM), a frequency filter, a low noise amplifier (LNA), an antenna, or the like. According to another embodiment, at least one of the cellular module 1621, the Wi-Fi module 1623, the BT module 1625, the GNSS module 1627, and the NFC module 1628 may transmit/receive an RF signal through a separate RF module.

The subscriber identification module 1624 may include, for example, a card including a subscriber identification module and/or an embedded SIM, or may include unique identification information (e.g., integrated circuit card identifier (ICCID)) or subscriber information (e.g., an international mobile subscriber identity (IMSI)).

The memory 1630 (e.g., the memory 130) may include, for example, an embedded memory 1632 or an external memory 1634. The embedded memory 1632 may include at least one of, for example, a volatile memory (e.g., a Dynamic Random Access Memory (DRAM), a Static RAM (SRAM), a Synchronous Dynamic RAM (SDRAM), and the like) and a non-volatile memory (e.g., a OneTime Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard drive, or a Solid State Drive (SSD).

The external memory 1634 may further include a flash drive, for example, a compact flash (CF), a secure digital (SD), a micro secure digital (Micro-SD), a mini secure digital (Mini-SD), an extreme digital (xD), a multi-media card (MMC), a memory stick, and the like. The external memory 1634 may be functionally and/or physically connected to the electronic device 1601 through various interfaces.

The sensor module 1640 may, for example, measure a physical quantity or detect the operating state of the electronic device 1601, and may convert the measured or detected information into an electrical signal. The sensor module 1640 may include, for example, at least one of a gesture sensor 1640A, a gyro sensor 1640B, an atmospheric pressure sensor 1640C, a magnetic sensor 1640D, an acceleration sensor 1640E, a grip sensor 1640F, a proximity sensor 1640G, a color sensor 1640H (e.g., an Red, Green, and Blue (RGB) sensor), a biometric sensor 1640I, a temperature/humidity sensor 1640J, an illuminance sensor 1640K, and an ultraviolet (UV) sensor 1640M. Additionally or alternatively, the sensor module 1640 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 1640 may further include a control circuit for controlling one or more sensors included therein. According to an embodiment, the electronic device 1601 may further include a processor, which may be configured to control the sensor module 1640, as a part of the processor 1610 or separately from the processor 1610, in order to control the sensor module 1640 while the processor 1610 is in a sleep state.

The input device 1650 may include, for example, a touch panel 1652, a (digital) pen sensor 1654, a key 1656, and an ultrasonic input unit 1658. The touch panel 1652 may use, for example, at least one of a capacitive type, a resistive type, an infrared type, and an ultrasonic type. Furthermore, the touch panel 1652 may further include a control circuit. The touch panel 1652 may further include a tactile layer to provide a tactile reaction to a user.

The (digital) pen sensor 1654 may include, for example, a recognition sheet which is a part of a touch panel or is separated from the touch panel. The key 1656 may include, for example, a physical button, an optical key, or a keypad. The ultrasonic input device 1658 may detect ultrasound waves generated from an input device by using a microphone (e.g., the microphone 1688), and identify data corresponding to the detected ultrasound waves.

The display 1660 (e.g., the panel 1662) may be embodied to be, for example, flexible, transparent, or wearable. The panel 1662 and the touch panel 1652 may be formed as one module. The hologram device 1664 may show a three dimensional image in the air by using interference of light. The projector 1666 may display an image by projecting light onto a screen. The screen may be located, for example, in the interior of, or on the exterior of, the electronic device 1601. According to an embodiment, the display 1660 may further include a control circuit for controlling the panel 1662, the hologram device 1664, or the projector 1666.

The interface 1670 may include, for example, a High-Definition Multimedia Interface (HDMI) 1672, a Universal Serial Bus (USB) 1674, an optical interface 1676, or a D-subminiature (D-sub) 1678. The interface 1670 may be included, for example, in the communication interface 170 illustrated in FIG. 1. Additionally or alternatively, the interface 1670 may include, for example, a Mobile High-definition Link (MHL) interface, a Secure Digital (SD) card/Multi-Media Card (MMC) interface, or an Infrared Data Association (IrDA) standard interface.

For example, the audio module 1680 may execute bidirectional conversion between a sound and an electrical signal. At least some elements of the audio module 1680 may be included in, for example, the input/output interface 145 illustrated in FIG. 1. The audio module 1680 may process sound information that is input or output through, for example, a speaker 1682, a receiver 1684, earphones 1686, the microphone 1688, and the like.

The camera module 1691 is a device for capturing an image or a video, and may include one or more image sensors (e.g., a front side sensor or a back side sensor), a lens, an image signal processor (ISP), or a flash (e.g., an LED or xenon lamp).

The power management module 1695 may manage, for example, the power of the electronic device 1601. According to an embodiment, the power management module 1695 may include a power management integrated circuit (PMIC), a charger integrated circuit (IC), or a battery or fuel gauge. The PMIC may use a wired and/or wireless charging method. The wireless charging method may include, for example, a magnetic resonance method, a magnetic induction method, an electromagnetic wave method, and the like. Additional circuits (e.g., a coil loop, a resonance circuit, a rectifier, and the like) for wireless charging may be further included. The battery gauge may measure, for example, the amount of charge remaining in the battery 1696 and a voltage, current, or temperature while charging. The battery 1696 may include, for example, a rechargeable battery and/or a solar battery.

The indicator 1697 may display a predetermined state of the electronic device 1601 or a part of the electronic device 1601 (e.g., the processor 1610), such as a boot-up state, a message state, a charging state, or the like. The motor 1698 may convert an electrical signal into a mechanical vibration, and may generate a vibration, a haptic effect, or the like. Although not illustrated, the electronic device 1601 may include a processing device (e.g., a GPU) for supporting mobile TV. The processing unit for supporting the mobile TV may process media data according to a standard, such as digital multimedia broadcasting (DMB), digital video broadcasting (DVB), MediaFlo™ and the like.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

FIG. 17 is a block diagram 1700 of the program module 1710 according to various embodiments of the present disclosure. According to an embodiment, the program module 1710 may include an operating system (OS) that controls resources related to an electronic device and/or various applications (e.g., application programs) driven in the OS. The operating system may be, for example, Android™, iOS™ Windows™, Symbian™, Tizen™, Samsung Badaos™, or the like.

The programming module 1710 may include a kernel 1720, middleware 1730, an Application Programming Interface (API) 1760, and/or an application 1770. At least a part of the program module 1710 may be preloaded to the electronic device, or may be downloaded from a server.

The kernel 1720 may include, for example, a system resource manager 1721 or a device driver 1723. The system resource manager 1721 may control, allocate, or collect the system resources. According to one embodiment of the present disclosure, the system resource manager 1721 may include a process management unit, a memory management unit, or a file system management unit. The device driver 1723 may include, for example, a display driver, a camera driver, a Bluetooth driver, a shared memory driver, a USB driver, a keypad driver, a Wi-Fi driver, an audio driver, or an inter-process communication (IPC) driver.

The middleware 1730 may provide a function required by the applications 1770 in common or provide various functions to the applications 1770 through the API 1760 so that the applications 1770 may efficiently use limited system resources of the electronic device. According to an embodiment of the present disclosure, the middleware 1730 may include at least one of a run time library 1735, an application manager 1741, a window manager 1742, a multimedia manager 1743, a resource manager 1744, a power manager 1745, a database manager 1746, a package manager 1747, a connectivity manager 1748, a notification manager 1749, a location manager 1750, a graphic manager 1751, and a security manager 1752.

The run time library 1735 may include, for example, a library module that a compiler uses in order to add new functions through a programming language while the application 1770 is executed. The run time library 1735 may perform input/output management, memory management, a function for an arithmetic function, or the like.

The application manager 1741 may manage, for example, a life cycle of at least one application among the applications 1770. The window manager 1742 may manage a GUI resource used in a screen. The multimedia manager 1743 may recognize a format required for reproducing various media files, and may encode or decode a media file using a codec appropriate for a corresponding format. The resource manager 1744 may manage resources such as a source code, a memory, or a storage space of at least one application among the applications 1770.

The power manager 1745 may operate together with, for example, a Basic Input/Output System (BIOS) to manage a battery or power, and may provide power information required for the operation of the electronic device. The database manager 1746 may generate, search for, or change a database to be used by at least one of the applications 1770. The package manager 1747 may manage installing or updating applications distributed in the form of a package file.

For example, the connectivity manager 1748 may manage wireless connections, such as WIFI, Bluetooth, or the like. The notification manager 1749 may display or report an event, such as reception of a message, an appointment, a proximity notification, and the like, to a user without disturbance. The location manager 1750 may manage location information of the electronic device. The graphic manager 1751 may manage graphic effects to be provided to a user or user interfaces related to the graphic effects. The security manager 1752 may provide various security functions required for system security, user authentication, or the like. According to an embodiment of the present disclosure, when the electronic device (e.g., the electronic device of FIG. 8) has a telephone call function, the middleware 1730 may further include a telephony manager for managing a voice or video call function of the electronic device.

The middleware 1730 may include a middleware module for forming a combination of various functions of the aforementioned elements. The middleware 1730 may provide modules specialized according to the type of OS in order to provide differentiated functions. In addition, some existing elements may be dynamically removed from the middleware 1730, or new elements may be added to the middleware 1730.

The API 1760 is, for example, a set of API programming functions, and may be provided in a different configuration for each operating system. For example, one API set may be provided for each platform in the case of Android or iOS, and two or more API sets may be provided for each platform in the case of Tizen.

The applications 1770 may include, for example, one or more applications which are capable of providing functions such as home 1771, dialer 1772, SMS/MMS 1773, Instant Message (IM) 1774, browser 1775, camera 1776, alarm 1777, contacts 1778, voice dial 1779, email 1780, calendar 1781, media player 1782, album 1783, clock 1784, health care (e.g., measuring exercise quantity or blood sugar), environment information (e.g., atmospheric pressure, humidity, or temperature information), and the like.

According to an embodiment, the applications 1770 may include an application (hereinafter, referred to as “an information exchange application” for convenience of description) for supporting exchanging of information between the electronic device (e.g., the electronic device of FIG. 1 or FIG. 2) and an external electronic device. The information exchange application may include, for example, a notification relay application for transmitting predetermined information to the external electronic device, or a device management application for managing the external electronic device.

For example, the notification relay application may have a function of transferring notification information generated by other applications of the electronic device (e.g., the SMS/MMS application, the e-mail application, the health care application, the environmental information application, or the like) to the external electronic device. Further, the notification relay application may receive notification information from, for example, an external electronic device, and may provide the received notification information to a user. For example, the device management application may manage (e.g., install, delete, or update) at least one function of the external electronic device communicating with the electronic device (e.g., a function of turning on/off the external electronic device itself (or some components) or a function of adjusting brightness (or a resolution) of the display), applications operating in the external electronic device, or services provided by the external electronic device (e.g., a call service and a message service).

According to an embodiment of the present disclosure, the application 1770 may include an application (e.g., a health management application) designated according to attributes of the external electronic device (e.g., attributes of the electronic device, and the type of electronic device is a mobile medical device). According to an embodiment, the applications 1770 may include applications received from an external electronic device. According to an embodiment of the present disclosure, the applications 1770 may include a preloaded application or a third party application that may be downloaded from a server. The names of the elements of the program module 1710 of the illustrated embodiment of the present disclosure may be changed according to the type of operating system.

According to various embodiments of the present disclosure, at least a part of the programming module 1710 may be embodied as software, firmware, hardware, or a combination of two or more thereof. At least a part of the programming module 1710 may be implemented (e.g., executed) by, for example, the processor (e.g., the AP 3310). At least a part of the programming module 1710 may include, for example, modules, programs, routines, sets of instructions, processes, or the like for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” or “function unit” may be a minimum unit of an integrated component element or a part thereof. The “module” may be a minimum unit for performing one or more functions or a part thereof. The “module” or “function unit” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. When the command is executed by one or more processors (for example, the processor 220), the one or more processors may execute a function corresponding to the command. The computer-readable storage medium may be, for example, the memory 240.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware electronic device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Furthermore, some operations may be executed in a different order or may be omitted, or other operations may be added.

According to various embodiments, a storage medium stores instructions and the instructions are configured to enable at least one processor to perform at least one operation when the instructions are executed by the at least one processor. The at least one operation includes: displaying content by a display installed in a first side of the electronic device; sensing incident light by a sensor installed in a second side of the electronic device; determining brightness information around the electronic device at least based on the sensed light; and adjusting at least one property of the display or at least one property of the content at least based on the brightness information.

Various embodiments of the present disclosure disclosed in this specification and the drawings are merely specific examples presented in order to easily describe technical details of the present disclosure and to help the understanding of the present disclosure, and are not intended to limit the scope of the present disclosure. Therefore, it should be construed that, in addition to the embodiments disclosed herein, all modifications and changes or modified and changed forms derived from the technical idea of various embodiments of the present disclosure fall within the scope of the present disclosure.

1. An electronic device, comprising:
a display for displaying content in a direction corresponding to a first side of the electronic device;
a sensor for sensing light incident to a second side of the electronic device; and
a processor,
wherein the processor is configured to perform: determining brightness information around the electronic device at least based on the sensed light; and adjusting at least one property of the display or at least one property of the content at least based on the brightness information.

2. The electronic device of claim 1, further comprising:
another sensor for sensing light incident to the first side,
wherein the processor is configured to perform the determining if another brightness information, which is determined based on light sensed by the another sensor, belongs to a designated range.

3. The electronic device of claim 1, further comprising:
another sensor for sensing light incident to the first side,
wherein the processor is configured to perform the adjusting further based on another brightness information, which is determined based on light sensed by the another sensor.

4. The electronic device of claim 1, wherein the sensor comprises an image sensor, and further comprises an image signal processing unit including a first functional block and a second functional block, for processing the light obtained from the sensor, and
the processor is configured to select a functional block related to the brightness information from among the first functional block and the second functional block, and to perform the determining using the selected functional block.

5. The electronic device of claim 4, wherein the processor is configured to bypass a functional block, which is not selected from among the first functional block and the second functional block, during the determining, or to turn off power applied to the second functional block.

6. The electronic device of claim 1, wherein the sensor comprises a plurality of pixels including a red pixel, a green pixel, or a blue pixel, and
the processor is configured to perform the determining based on color information corresponding to a pixel designated from among the plurality of pixels, and to select, as the designated pixel, one or more pixels, a number of which is the smallest from among the plurality of pixels.

7. The electronic device of claim 1, wherein the processor is configured to determine the brightness information based on at least one of color information corresponding to the light and time information when the sensor is exposed to the light.

8. The electronic device of claim 1, wherein the at least one property of the display or the at least one property of the content includes luminance, chroma, white balance, color, or a combination thereof.

9. The electronic device of claim 1, further comprising:
a housing forming at least a part of an external surface of the electronic device, wherein the sensor forms at least a part of the housing, and is located between the display and the housing.

10. The electronic device of claim 1, further comprising:
an image pre-processing module between the sensor and the processor,
wherein the processor turns off at least one functional block from among a plurality of functional blocks included in the image pre-processing module if a predetermined condition for determining brightness of the display is satisfied.

11. A method of an electronic device, the method comprising:
displaying content by a display installed in a first side of the electronic device;
sensing incident light by a sensor installed in a second side of the electronic device;
determining brightness information around the electronic device at least based on the sensed light; and
adjusting at least one property of the display or at least one property of the content at least based on the brightness information.

12. The method of claim 11, wherein, if another brightness information, which is determined based on light sensed by another sensor for sensing light incident to the first side, belongs to a designated range, the determining is performed.

13. The method of claim 11, wherein the adjusting is performed further based on another brightness information, which is determined based on light sensed through another sensor for sensing light incident to the first side.

14. The method of claim 11, further comprising: determining whether a predetermined condition for adjusting the property of the display is satisfied; and processing data received from the first sensor or the second sensor if the predetermined condition is satisfied.

15. The method of claim 14, wherein the predetermined condition is determined based on at least one of display state information of the electronic device, information related to movement of the electronic device, surrounding environment information of the electronic device, and information related to a cover attached to the electronic device.
